(19) United States
(12) Patent Application Publication
(10) Pub. No.: US 2017/0153591 A1
(43) Pub. Date: Jun. 1, 2017

(54) IMAGE FORMING APPARATUS

(71) Applicants: Makoto NAKURA, Kanagawa (JP); Yuji KARIKUSA, Ibaraki (JP); Kohji TOKUYAMA, Ibaraki (JP); Tohru MATSUMOTO, Ibaraki (JP); Daisuke ARAI, Ibaraki (JP)

(72) Inventors: Makoto NAKURA, Kanagawa (JP); Yuji KARIKUSA, Ibaraki (JP); Kohji TOKUYAMA, Ibaraki (JP); Tohru MATSUMOTO, Ibaraki (JP); Daisuke ARAI, Ibaraki (JP)

(73) Assignee: Ricoh Company, Ltd., Tokyo (JP)

(21) Appl. No.: 15/432,106

(22) Filed: Feb. 14, 2017

Related U.S. Application Data
(62) Division of application No. 14/749,776, filed on Jun. 25, 2015.

(30) Foreign Application Priority Data
Jun. 30, 2014 (JP) 2014-135231
Jun. 2, 2015 (JP) 2015-112459

(51) Int. Cl. G03G 15/00

(52) U.S. Cl. CPC G03G 15/6567

(57) ABSTRACT

An image forming apparatus including an image forming unit configured to form an image on a recording medium; an edge detecting unit configured to detect edge positions at a plurality of portions along each side of the recording medium being conveyed; a shape detecting unit configured to detect a shape of the recording medium, based on an edge detection result obtained by the edge detecting unit; and an image correcting unit configured to correct the image to be formed on the recording medium, based on a change in the shape of the recording medium before and after image forming, the change being detected by the shape detecting unit.

### CROSS-REFERENCES TO RELATED APPLICATIONS

This application is a divisional application of and claims the benefit of priority under 35 U.S.C. 120 to patent application Ser. No. 14/749,776 filed on Jun. 25, 2015, which claims priority to Japanese Patent Application No. 2014-135231, filed on Jun. 30, 2014, and Japanese Patent Application No. 2015-112459, filed on Jun. 2, 2015, the entire contents of which are hereby incorporated herein by reference.

### BACKGROUND OF THE INVENTION

1. Field of the Invention

The present invention relates to an image forming apparatus.

2. Description of the Related Art

In the field of commercial printing, including small lot, multiple type, variable data printing, etc., shift is progressing from the conventional offset printer to POD (Print On Demand) using an image forming apparatus, etc., of an electrophotographic method. In an image forming apparatus of an electrophotographic method, in order to respond to such needs, there is growing demand for accuracy of image positions on both sides of a sheet and uniformity in images, which equal those of an offset printer.

The factors of deviations of image positions on both sides of a sheet in an image forming apparatus, may be roughly divided in to the registration error in the vertical direction and the horizontal direction, a skew error between the recording medium and the print image, and expansion and contraction in the image length at the time of toner image transfer. Furthermore, in an image forming apparatus including a fixing device, a deviation of image positions on both sides of a sheet may be caused as the recording medium expands or contracts by being heated by the fixing device.

Accordingly, there is disclosed an image forming apparatus that changes the image magnification ratio and the image position with respect to the sheet for the image that is transferred next, based on the measurement result of the sheet size obtained by a sheet size measuring unit, before and after fixing the transferred image on the sheet (see, for example, Patent Document 1).

According to the image forming apparatus of Patent Document 1, deviations of image positions on both sides of a sheet are reduced by changing the image magnification ratio and the image position according to the expansion and contraction of the sheet, and matching the image sizes and the positions of the images to be formed on the front side and back side of the sheet.

However, a sheet that is rectangular before fixing may not be rectangular after fixing; the sheet may be deformed in to a different shape from that before fixing, as a result of receiving heat and pressure. Therefore, there are cases where the sizes and the positions of the images formed on both sides of the sheet cannot be matched with high precision, only by changing the image magnification ratio and the image position according to the expansion and contraction of the sheet.

Patent Document 1: Japanese Laid-Open Patent Publication No. 2004-045476

### SUMMARY OF THE INVENTION

The present invention provides an image forming apparatus, in which one or more of the above-described disadvantages are eliminated.

According to an aspect of the present invention, there is provided an image forming apparatus including an image forming unit configured to form an image on a recording medium; an edge detecting unit configured to detect edge positions at a plurality of portions along each side of the recording medium being conveyed; a shape detecting unit configured to detect a shape of the recording medium, based on an edge detection result obtained by the edge detecting unit; and an image correcting unit configured to correct the image to be formed on the recording medium, based on a change in the shape of the recording medium before and after image forming, the change being detected by the shape detecting unit.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a schematic configuration of an image forming apparatus according to a first embodiment;

FIG. 2 is a side view of an example of a schematic configuration of a shape measuring device according to the first embodiment;

FIG. 3 is a plan view of an example of a schematic configuration of the shape measuring device according to the first embodiment;

FIG. 4 is a functional block diagram of an example of the image forming apparatus according to the first embodiment;

FIGS. 5A and 5B illustrate an example of detection positions of the sheet width according to the first embodiment;

FIG. 6 illustrates an example of an edge detection result obtained by a CIS according to the first embodiment;

FIGS. 7A and 7B illustrate an output example of a start trigger sensor, a stop trigger sensor, and an encoder according to the first embodiment;

FIG. 8 illustrates an example of a measurement result of a sheet shape according to the first embodiment;

FIG. 9 is a plan view of an example of a schematic configuration of a shape measuring device according to a second embodiment;

FIG. 10 illustrates an example of detection results of a sheet width and an image width according to the second embodiment;

FIGS. 11A and 11B illustrate an example of an edge detection result obtained by a CIS according to the second embodiment;

FIG. 12 illustrates an example of measurement results of a sheet shape and an image shape according to the second embodiment;

FIG. 13 is an example of a flowchart of an image correcting process according to the second embodiment;

FIG. 14 is a functional block diagram of an example of the image forming apparatus according to a third embodiment;

FIG. 15 illustrates an example of a margin of the sheet according to the third embodiment;

FIG. 16 illustrates an output example of a start trigger sensor, a stop trigger sensor, and an encoder according to the third embodiment;

FIG. 17 is a functional block diagram of an example of the image forming apparatus according to a fourth embodiment;

FIG. 18 illustrates an example of detection positions of a sheet and a detection-usage image according to the fourth embodiment; and

FIGS. 19A and 19B illustrate an output example of a start trigger sensor, a stop trigger sensor, and an encoder according to the fourth embodiment.

### DETAILED DESCRIPTION OF THE PREFERRED EMBODIMENTS

A description is given, with reference to the accompanying drawings, of embodiments of the present invention. In the drawings, the same elements are denoted by the same reference numerals, and overlapping descriptions may be omitted.

### First Embodiment

### <Image Forming Apparatus>

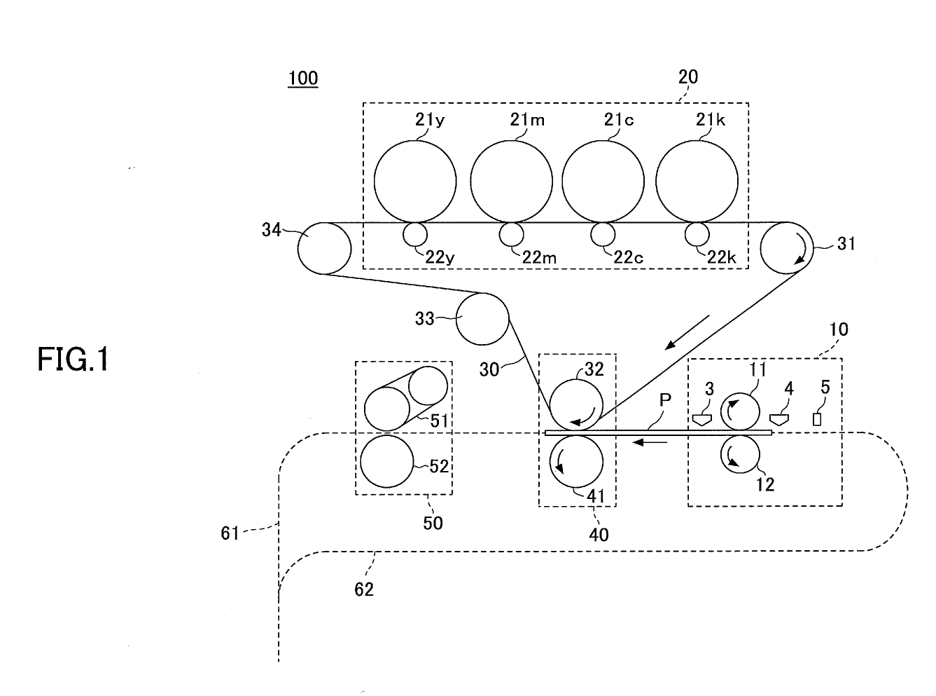

FIG. 1 illustrates an example of a schematic configuration of an image forming apparatus 100 according to a first embodiment.

As illustrated in FIG. 1, the image forming apparatus 100 includes a shape measuring device 10, an image forming unit 20, an intermediate transfer belt 30, a secondary transfer device 40, and a fixing device 50. The image forming unit 20, the intermediate transfer belt 30, the secondary transfer device 40, and the fixing device 50 are examples of an image forming unit, and form an image onto a conveyed sheet P as a recording medium.

The image forming unit 20 includes photoconductor drums 21y, 21m, 21c, 21k, and primary transfer rollers 22y, 22m, 22c, 22k. Note that y expresses yellow, m expresses magenta, c expresses cyan, and, k expresses black, but these letters may be omitted in the following description.

Around the photoconductor drum 21, a charging device for charging the photoconductor drum 21, an exposing device for exposing the surface of the charged photoconductor drum 21 based on image data, and a developing device for developing an electrostatic latent image formed on the surface of the photoconductor drum 21 into a toner image, are provided.

The primary transfer rollers 22 are arranged to face the corresponding photoconductor drums 21 via the intermediate transfer belt 30, and the primary transfer rollers 22 transfer toner images, which are formed on the corresponding photoconductor drums 21, onto the intermediate transfer belt 30 to be superposed on each other, thereby forming a full-color toner image on the intermediate transfer belt 30.

The intermediate transfer belt 30 is wound around a plurality of rollers 31, 32, 33, 34, at least one of which being a rotation driving roller that drivingly rotates, and the intermediate transfer belt 30 rotates in a clockwise direction as viewed in FIG. 1. The full-color toner image formed on the surface of the intermediate transfer belt 30 by the image forming unit 20, rotates and moves together with the intermediate transfer belt 30, and is transferred onto a conveyed sheet P at the secondary transfer device 40.

The secondary transfer device 40 includes a roller 32 as a transfer facing roller, and a secondary transfer roller 41 that is arranged to face the roller 32 via the intermediate transfer belt 30. The secondary transfer roller 41 is pressed against the roller 32 and also has a transfer electric field applied, and the secondary transfer roller 41 transfers the full-color toner image formed on the surface of the intermediate transfer belt 30 onto the sheet P.

The sheet P on which the full-color toner image has been transferred, is conveyed to the fixing device 50 by a conveying unit (not shown). The fixing device 50 includes a fixing belt 51 that is heated by, for example, a halogen lamp, and that rotates, and a pressurizing roller 52 that is pressed against the fixing belt 51. The fixing device 50 heats and pressurizes the sheet P between the fixing belt 51 and the pressurizing roller 52, and fixes the full-color toner image onto the sheet P.

In the case of single-sided printing, the sheet P undergoes the above process, and after an image is printed on the first side, the sheet P is ejected outside the image forming apparatus 100. In the case of double-sided printing, after an image has been formed on the first side of the sheet P, the sheet P is conveyed such that the front side and back side of the sheet P are reversed and the leading edge and the trailing edge the sheet P are reversed by a sheet reversing path 61 and a double-side conveying path 62, and an image is formed on the second side of the sheet P. The sheet P on which images have been formed on both sides, is ejected outside the image forming apparatus 100 similar to the case of single-sided printing.

The image forming apparatus 100 according to the present embodiment has a configuration of transferring the toner image from the intermediate transfer belt 30 to the sheet P; however, the image forming apparatus 100 may have a configuration of directly transferring monochrome toner images, which have been formed on a plurality of photoconductor drums 21, onto the sheet so as to be superposed on each other. Furthermore, the image forming apparatus 100 may be a monochrome image forming apparatus for forming monochrome images such as a black image.

### <Shape Measuring Device>

As illustrated in FIG. 1, a shape measuring device 10 is provided in the conveying path of the sheet P in the image forming apparatus 100. The image forming apparatus 100 obtains the shape of the sheet P, based on the length of the sheet P in the conveying direction (hereinafter, “length”) and the length of the sheet P in the width direction orthogonal to the conveying direction (hereinafter, “width”) obtained by the shape measuring device 10.

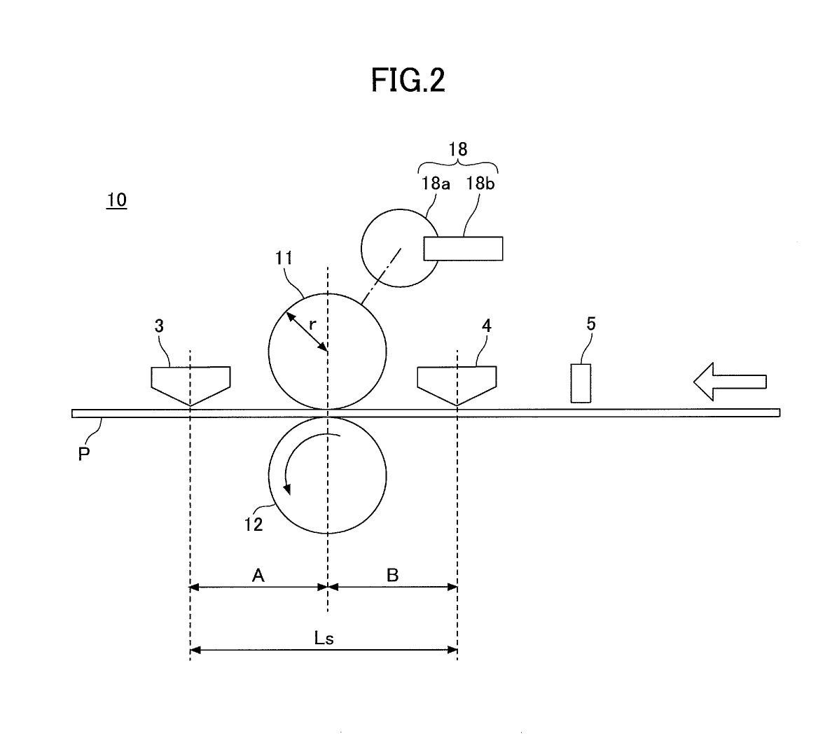

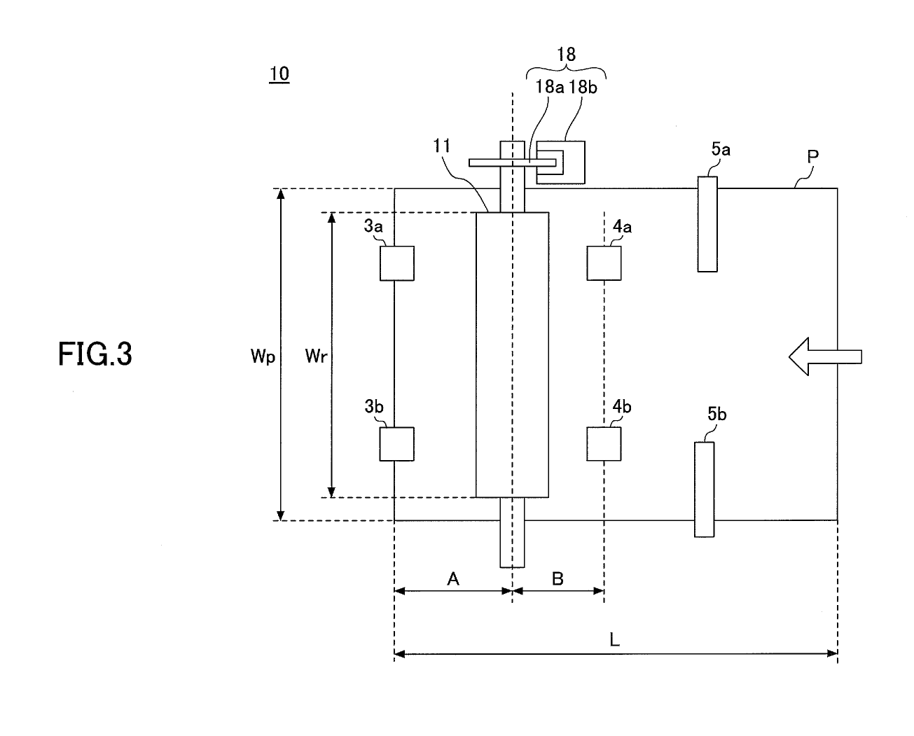

The configuration of the shape measuring device 10 is described with reference to FIGS. 2 and 3. FIG. 2 is a side view of an example of a schematic configuration of the shape measuring device 10 according to the first embodiment. FIG. 3 is a plan view of an example of a schematic configuration of the shape measuring device 10 according to the first embodiment.

As illustrated in FIGS. 2 and 3, the shape measuring device 10 includes a driven roller 11 and a driving roller 12 as a conveying unit, an encoder 18, a first start trigger sensor 3a, a second start trigger sensor 3b, a first stop trigger sensor 4a, a second stop trigger sensor 4b, and a CIS (Contact Image Sensor) 5.

A roller pair constituted by the driven roller 11 and the driving roller 12 is an example of a conveying unit. The driving roller 12 receives a driving force of a driving unit (not shown) such as a motor, and drivingly rotates in a direction indicated by an arrow in FIG. 2. The driven roller 11 sandwiches the sheet P with the driving roller 12 and conveys the sheet P. The driven roller 11 is rotated by the sheet P when conveying the sheet P, and is rotated by the driving roller 12 when the sheet P is not conveyed.

A length Wr of the driven roller 11 in the width direction orthogonal of the conveying direction of the sheet P, is preferably less than or equal to the minimum width Wp of the sheet P that the image forming apparatus 100 handles, as illustrated in FIG. 3. By such a configuration, the driven roller 11 is driven and rotated only by the friction that occurs between the driven roller 11 and the sheet P, without contacting the driving roller 12, when conveying the sheet P. Therefore, the driven roller 11 is not affected by the driving roller 12 when conveying the sheet P, such that the length of the sheet P can be obtained more accurately, by the method described below.

The encoder 18 includes an encoder disk 18a and an encoder sensor 18b, and is provided on the rotational shaft of the driven roller 11. The encoder disk 18a is a disk in which a plurality of slits are formed at equally-spaced intervals along the periphery, and the encoder disk 18a is rotated together with the driven roller 11. The encoder sensor 18b is provided in a fixed manner on the periphery of the encoder disk 18a, and detects the slits of the encoder disk 18a that rotates together with the driven roller 11, and outputs pulse signals.

Note that in the present embodiment, the encoder 18 is provided on the rotational shaft of the driven roller 11; however, the encoder 18 may be provided on the rotational shaft of the driving roller 12. The diameter of the roller on which the encoder 18 is provided, is preferably as small as possible, because the rotational frequency when conveying the sheet P increases, and the number of pulse signals output from the encoder sensor 18b increases, and the length of the sheet P can be obtained with high precision by the method described below.

Furthermore, the driven roller 11 or the driving roller 12 to which the encoder 18 is attached, is preferably made of a metal roller for securing axial deflection precision. As the deflection of the rotational axis is reduced, the length of the sheet P can be measured with high precision by the method described below.

The first start trigger sensor 3a and the second start trigger sensor 3b (hereinafter, also simply referred to as “start trigger sensor 3”) are an example of a leading edge detecting unit, and is provided on the downstream side of the driven roller 11 and the driving roller 12 in the conveying direction of the sheet P. The first start trigger sensor 3a and the second start trigger sensor 3b are arranged at different positions in the width direction orthogonal to the conveying direction of the sheet P as illustrated in FIG. 3, and respectively detect the leading edge of the sheet P being conveyed.

Furthermore, the first stop trigger sensor 4a and the second stop trigger sensor 4b (hereinafter, also simply referred to as “stop trigger sensor 4”) are an example of a trailing edge detecting unit, and are provided on the upstream side of the driven roller 11 and the driving roller 12 in the conveying direction of the sheet P. The first stop trigger sensor 4a and the second stop trigger sensor 4b are arranged at different positions in the width direction orthogonal to the conveying direction of the sheet P as illustrated in FIG. 3, and respectively detect the trailing edge of the sheet P being conveyed. The start trigger sensor 3 and the stop trigger sensor 4 are, for example, a transmission type or a reflection type optical sensor.

Note that the first start trigger sensor 3a and the second start trigger sensor 3b are preferably provided at the same position in the conveying direction of the sheet P, because it would be easy to perform the process of detecting the sheet shape. Similarly, the first stop trigger sensor 4a and the second stop trigger sensor 4b are preferably provided at the same position in the conveying direction of the sheet P.

Furthermore, the first start trigger sensor 3a and the first stop trigger sensor 4a are preferably provided at the same position in the width direction of the sheet P. Similarly, the second start trigger sensor 3b and the second stop trigger sensor 4b are preferably provided at the same position in the width direction of the sheet P.

Furthermore, in the present embodiment, two of each of the start trigger sensor 3 and the stop trigger sensor 4 are provided; however, in order to obtain the shape of the sheet P with higher precision, three or more of each may be provided.

In FIGS. 2 and 3, the distance A is the distance between the start trigger sensor 3 and each of the driven roller 11 and the driving roller 12 in the conveying direction of the sheet P. Furthermore, the distance B is the distance between the stop trigger sensor 4 and each of the driven roller 11 and the driving roller 12. The distance A and the distance B are preferably as short as possible, such that the length of the sheet P can be obtained with high precision by the method described below.

The CIS 5 is an example of a width direction edge detecting unit, and detects the edge position of the conveyed sheet P in the width direction. In the first embodiment, a CIS 5a and a CIS 5b are respectively provided at both edges in the width direction of the sheet P; however, a single CIS 5 having a length that is greater than or equal to the width of the sheet P may be used to detect the positions on both edges of the sheet P in the width direction.

Note that in the shape measuring device 10 according to the first embodiment, the CIS 5 is provided on the upstream side of the driven roller 11 and the driving roller 12 in the conveying direction of the sheet P; however, the CIS 5 may be provided on the downstream side of the driven roller 11 and the driving roller 12.

In the shape measuring device 10, an edge detecting unit including the start trigger sensor 3, the stop trigger sensor 4, and the CIS 5 detects the edge positions at a plurality of portions along the sides of the rectangular sheet P being conveyed. The image forming apparatus 100 detects the shape of the sheet P before an image is formed on the first side and detects the shape of the sheet P before an image is formed on the second side when performing double-sided printing, based on the detection result obtained by the shape measuring device 10, and obtains the change in the shape of the sheet P before and after image forming. Based on the change in the shape of the sheet P when performing double-sided printing, the image forming apparatus 100 corrects the size, the position, the shape, etc., of the image to be printed on the second side of the sheet P whose shape has been measured, and the images to be printed on the first side and the second side of a subsequent sheet P.

Note that the shape measuring device 10 is to be provided on the conveying path extending up to a where the sheet P, on which an image has been formed on the first side, is conveyed to have an image formed on the second side, and the shape measuring device 10 may be provided at a different position than that of the present embodiment. However, when performing double-sided printing on the sheet P, the sheet P deforms by expanding or contracting by receiving heat or pressure when passing through the fixing device 50 at the time of printing on the first side, and continues to deform along with the decrease in the temperature even after passing through the fixing device 50. Therefore, in order to correct the magnification ratio of the image to be printed on the second side of the sheet P with high precision, it is preferable to obtain the shape immediately before an image is transferred on the second side of the sheet P, and therefore the shape measuring device 10 is preferably provided on the immediate upstream side of the secondary transfer device 40.

### <Functional Configuration of Image Forming Apparatus>

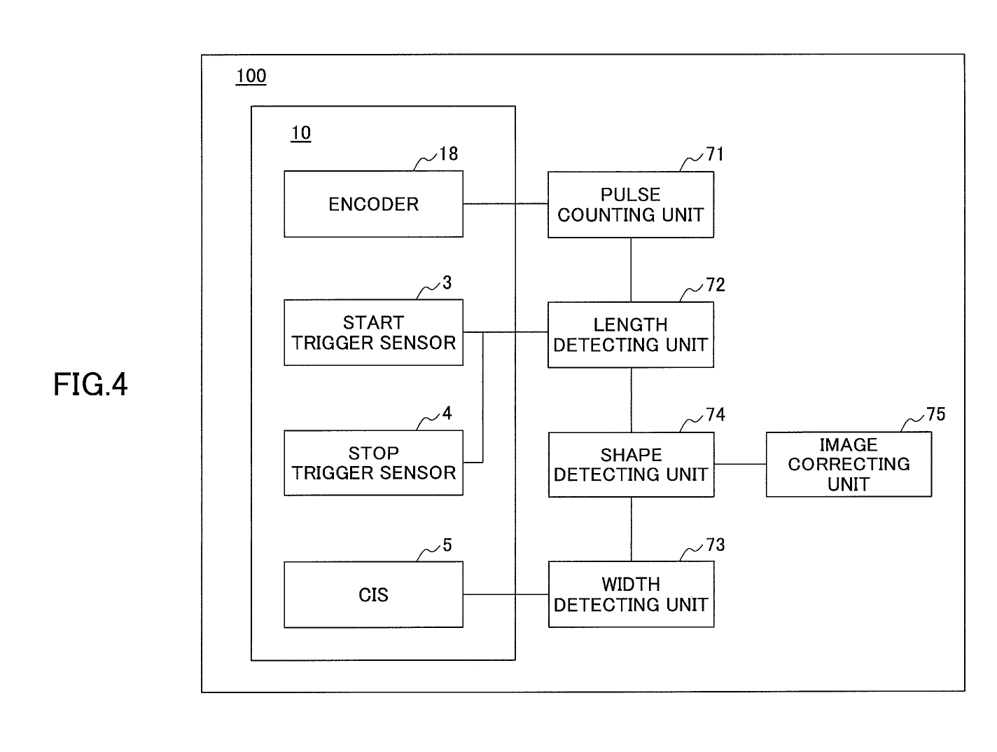

FIG. 4 is a functional block diagram of an example of the image forming apparatus 100 according to the first embodiment.

As illustrated in FIG. 4, the image forming apparatus 100 includes a shape measuring device 10, a pulse counting unit 71, a length detecting unit 72, a width detecting unit 73, a shape detecting unit 74, and an image correcting unit 75. As described above, the shape measuring device 10 includes a start trigger sensor 3, a stop trigger sensor 4, a CIS 5, and an encoder 18.

The above functions of the image forming apparatus 100 are realized by, for example, the cooperation between programs stored in a ROM and hardware such as a CPU and a RAM. Note that one or more of the above functions of the image forming apparatus 100 may be provided in the shape measuring device 10.

The pulse counting unit 71 counts pulse signals output from the encoder sensor 18b as the encoder disk 18a of the encoder 18 rotates together with the driven roller 11, and measures the rotational frequency of the driven roller 11 rotated by the sheet P. The encoder 18 and the pulse counting unit 71 are an example of a rotational frequency measuring unit.

The length detecting unit 72 detects the length of the sheet P, based on the edge detection result of the sheet P based on output from the start trigger sensor 3 and the stop trigger sensor 4, and the number of pulses output from the encoder sensor 18b counted by the pulse counting unit 71.

The width detecting unit 73 detects the width of the sheet P based on the edge position detection result in the width direction of the sheet P by the CIS 5.

The shape detecting unit 74 detects the shape of the sheet P, based on the length of the sheet P obtained by the length detecting unit 72 and the width of the sheet P obtained by the width detecting unit 73.

The image correcting unit 75 corrects the size, the position, the shape, etc., of an image to be formed on the sheet P, based on the shape of the sheet P obtained by the shape detecting unit 74.

In the image forming apparatus 100, the image correcting unit 75 corrects the image to be formed on the sheet P based on the shape of the sheet P obtained by the shape detecting unit 74, and therefore double-sided printing can be performed with high accuracy of image positions on both sides of a sheet.

### <Detection of Sheet Shape>

Next, a description is given of a method of detecting the shape of the sheet P in the image forming apparatus 100. The shape of the sheet P is obtained by the shape detecting unit 74, based on the width of the sheet P detected by the width detecting unit 73 and the length of the sheet P in the conveying direction detected by the length detecting unit 72.

(Sheet Width Detection)

First, a description is given of a width detection method of the sheet P by the width detecting unit 73.

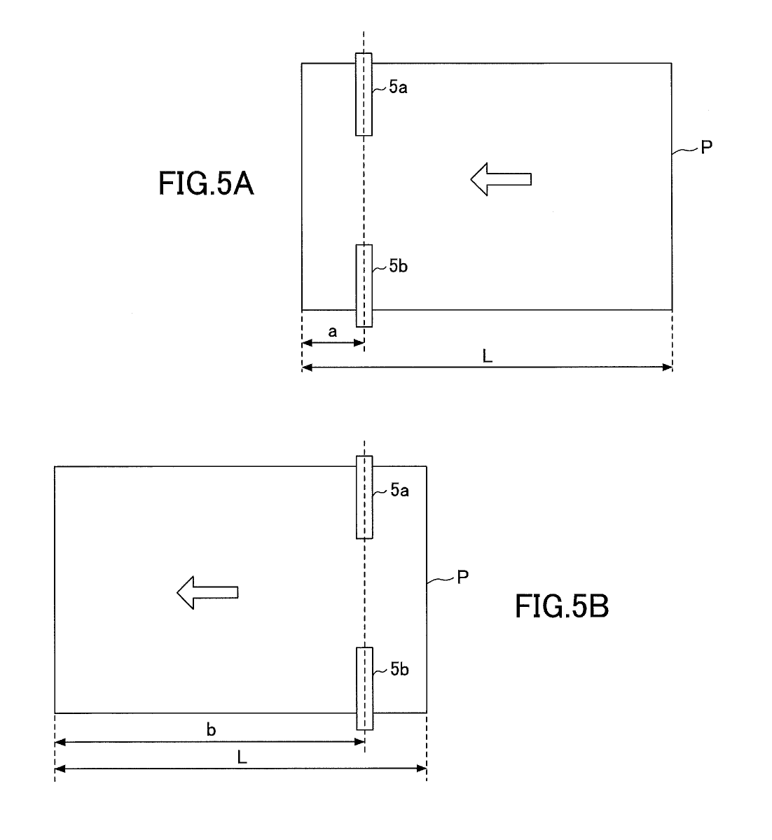

The width detecting unit 73 detects the width of the sheet P at a plurality of different positions along the conveying direction of the sheet P, based on output of the CIS 5. For example, the CIS 5 detects the width direction edge position of the sheet P at two positions at a distance a from the leading edge of the sheet P (FIG. 5A) and at a distance b from the leading edge of the sheet P (FIG. 5B), when a predetermined time passes after the stop trigger sensor 4 detects the leading edge of the sheet P.

Here, in a case of detecting the width of the sheet P at two positions as illustrated in FIGS. 5A and 5B, the total distance (a+b) from the leading edge of the sheet P to the detection position, is preferably set to be substantially equal to the length L of the sheet P that is set in advance. By such a setting, it is possible to detect the width of the sheet P at substantially the same positions before and after forming an image on the first side the sheet P that is conveyed such that the leading edge and the trailing edge are reversed when performing double-sided printing.

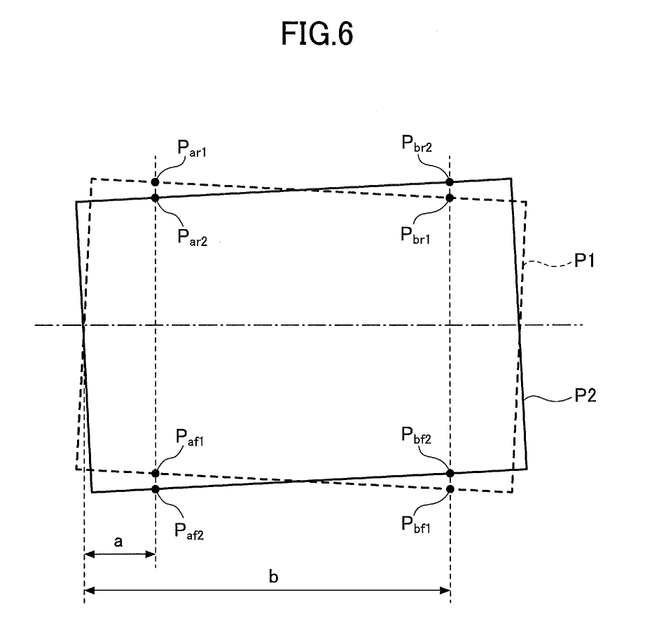

FIG. 6 illustrates an example of a sheet detection result obtained by the CIS 5 according to the first embodiment. In the CIS 5, a plurality of pixels are arranged in the width direction, which receive reflection light from the sheet P and output signals according to the amount of received light. The width detecting unit 73 acquires, as detection pixels corresponding to the width direction edge position of the sheet P, the number of pixels of the CIS 5 from a pixel at one edge side to the pixel from which the output signal value of the pixel changes according to whether there is the sheet P.

As illustrated in FIG. 6, the width detecting unit 73 acquires detection pixels P_{af1}, Pₐᵣ₁, corresponding to the width direction edge of the leading edge side, and detection pixels P_{bf1}, P_{br1}, corresponding to the width direction edge of the trailing edge side, in a sheet P1 before an image is formed on the first side. Furthermore, the width detecting unit 73 acquires detection pixels P_{af2}, Pₐᵣ₂, corresponding to the width direction edge of the leading edge side, and detection pixels P_{bf2}, P_{br2}, corresponding to the width direction edge of the trailing edge side, in a sheet P2 after an image is formed on the first side. The width detecting unit 73 can obtain the width of the sheet P at the respective detection positions before and after an image is formed on the first side, based on the difference in the detection pixels at the same length from the leading edge of the sheet P as described above.

Furthermore, the width detecting unit 73 is able to obtain, by the following formula (1), the width change amount ΔWₐ on the leading edge side in the conveying direction of the sheet P2 after an image is formed on the first side, and is able to obtain, by the following formula (2), the width change amount ΔW_{b} on the trailing edge side in the conveying direction of the sheet P2 after an image is formed on the first side.

ΔWₐ=(P_{af2}−P_{bf1})/DPI+(Pₐᵣ₂−P_{br1})/DPI (1)

ΔW_{b}=(P_{bf2}−P_{af1})/DPI+(P_{br2}−Pₐᵣ₁)/DPI (2)

Here, DPI is the pixel resolution [dot/inch] of the CIS 5.

As expressed by the above formulas (1) and (2), the sheet P is conveyed such that the leading edge and the trailing edge are reversed after an image is formed on the first side, and therefore the width change amount of the sheet P can be obtained by comparing the detection pixels at positions of different distances from the leading edge in the conveying direction before and after forming an image on the first side.

For example, in the following cases,

(P_{af2}−P_{bf1})=3 [dot]

(Pₐᵣ₂−P_{br1})=5 [dot]

(P_{bf2}−P_{af1})=4 [dot]

(P_{br2}−Pₐᵣ₁)=6 [dot]

DPI=300 [dot/inch],

based on the above formulas (1) and (2), the width change amounts ΔWₐ, ΔW_{b} of the sheet P can be obtained as follows.

$$\begin{matrix}{ΔW}_{a} = 3 / 300 + 5 / 300 \\ = 0.027 [ inch ] \\ = 0.68 [ mm ]\end{matrix}$$

$$\begin{matrix}{ΔW}_{b} = 4 / 300 + 6 / 300 \\ = 0.033 [ inch ] \\ = 0.85 [ mm ]\end{matrix}$$

As described above, in the above example, it can be known that the sheet P has contracted by 0.68 mm on the leading edge side in the conveying direction and by 0.85 mm on the trailing edge side in the conveying direction, after an image has been formed on the first side.

Note that the higher the pixel resolution of the CIS 5, the more preferable, because the width detection precision of the sheet P is increased. Furthermore, when the width detecting unit 73 performs an averaging process on the plurality of outputs of the CIS 5 to acquire a detection pixel position, the width detection precision of the sheet P is increased.

Furthermore, the above example describes a case where the width of the sheet P is detected at two positions at the distance a and the distance b from the leading edge of the sheet P, and the total distance of a and b are substantially equal to the length L of the sheet P; however, the width measuring positions may be at arbitrary positions. For example, assuming that the width detection position of the sheet P before forming an image on the first side is at distances a′, b′(a′+b′≠L) from the leading edge, the width detection positions of the sheet P that is reversed and conveyed after forming an image on the first side may be set at distances (L-a′), (L-b′) from the leading edge of the sheet P. By such a setting, it is possible to match the width detection positions of the sheet P before and after forming an image on the first side.

Furthermore, the width detecting unit 73 may detect the width of the sheet P at three or more positions. When the width of the sheet P is detected at three positions, for example, the width detection positions before forming an image on the first side are set to be distances X, Y, Z from the leading edge of the sheet P in the conveying direction, and the width detection positions of the sheet P that is reversed and conveyed after forming an image on the first side, are set to be at distances (L-X), (L-Y), (L-Z) from the leading edge of the sheet P in the conveying direction. By such a setting, the width detection positions of the sheet P before and after forming an image on the first side, can be matched.

Furthermore, in a case where the image forming apparatus 100 has a configuration of conveying the sheet P upon reversing only the front side and back side of the sheet P after forming an image on the first side, without reversing the leading edge and the trailing edge, the width change amount of the sheet P can be obtained in a similar manner, by changing the comparison positions of the detection pixels before and after forming an image on the first side.

(Sheet Length Detection)

Next, a description is given of a length detection method of the sheet P by the length detecting unit 72.

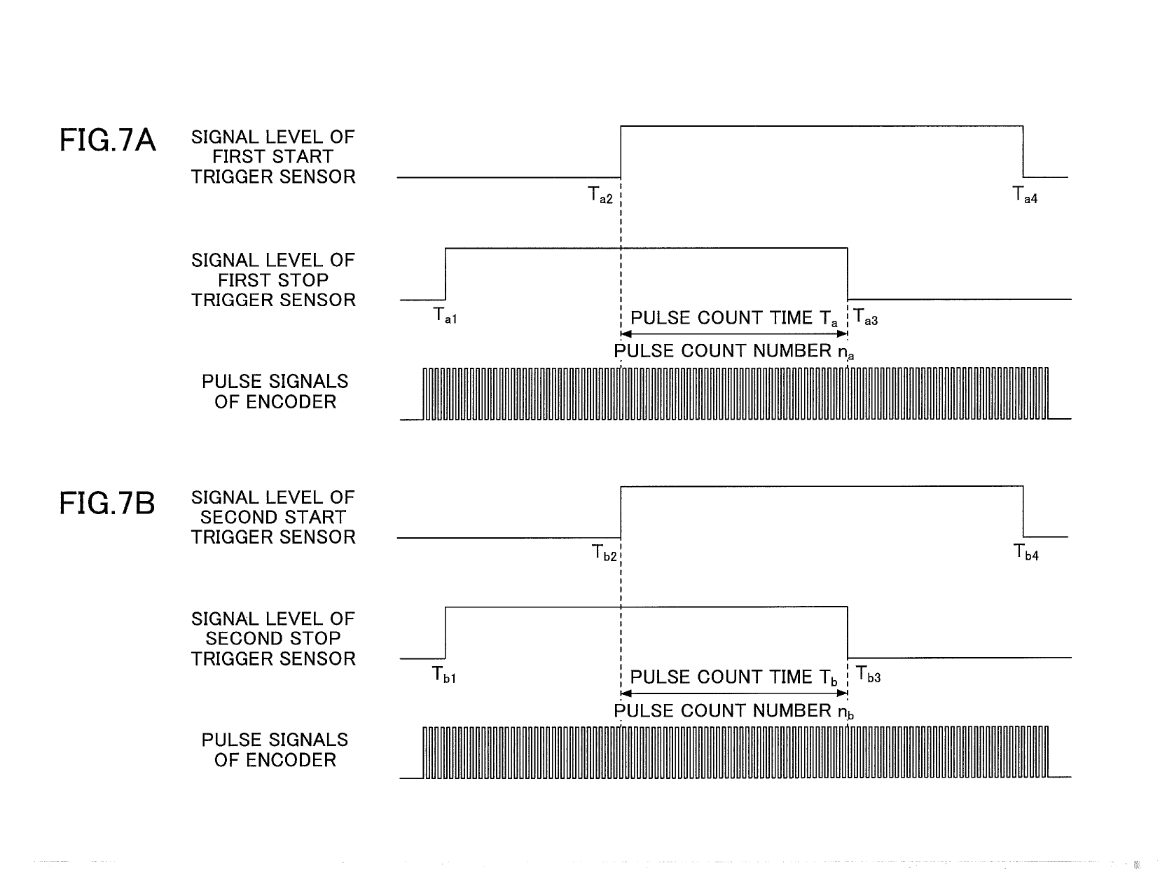

FIGS. 7A and 7B illustrate an output example of the start trigger sensor 3, the stop trigger sensor 4, and the encoder 18 according to the first embodiment. FIG. 7A illustrates an output example of the first start trigger sensor 3a, the first stop trigger sensor 4a, and the encoder 18. Furthermore, FIG. 7B illustrates an output example of the second start trigger sensor 3b, the second stop trigger sensor 4b, and the encoder 18.

In the image forming apparatus 100, when the image forming operation on the sheet P is started, and the driven roller 11 is rotated by the driving roller 12 or the sheet P in the shape measuring device 10, the encoder 18 outputs pulse signals.

In the examples of FIGS. 7A and 7B, at time Tₐ₁, the first stop trigger sensor 4a detects the leading edge of the sheet P in the conveying direction, and at time T_{b1}, the second stop trigger sensor 4b detects the leading edge of the sheet P in the conveying direction. Subsequently, the sheet P is conveyed by the driven roller 11 and the driving roller 12, and at time Tₐ₂, the first start trigger sensor 3a detects the leading edge of the sheet P in the conveying direction, and at time T_{b2}, the second start trigger sensor 3b detects the leading edge of the sheet P in the conveying direction.

Next, the sheet P is conveyed by the driven roller 11 and the driving roller 12, and at time Tₐ₃, the first stop trigger sensor 4a detects the trailing edge of the sheet P in the conveying direction, and at time T_{b3}, the second stop trigger sensor 4b detects the trailing edge of the sheet P in the conveying direction. Furthermore, the sheet P is conveyed and passes through the driven roller 11 and the driving roller 12, and at time Tₐ₄, the first start trigger sensor 3a detects the trailing edge of the sheet P in the conveying direction, and at time T_{b4}, the second start trigger sensor 3b detects the trailing edge of the sheet P in the conveying direction.

Here, the pulse counting unit 71 counts the pulse signals of the encoder 18 during a pulse count time Tₐ, from when the sheet leading edge is detected by the first start trigger sensor 3a at time Tₐ₂ to when the first stop trigger sensor 4a detects the sheet trailing edge at time Tₐ₃.

Similarly, the pulse counting unit 71 counts the pulse signals of the encoder 18 during a pulse count time T_{b}, from when the sheet leading edge is detected by the second start trigger sensor 3b at time T_{b2} to when the second stop trigger sensor 4b detects the sheet trailing edge at time T_{b3}.

It is assumed that the radius of the driven roller 11 on which the encoder 18 is provided is r, the number of encoder pulses of one rotation of the driven roller 11 is N, and the numbers of pulses counted at the pulse count times Tₐ, T_{b}, are nₐ, n_{b}, respectively. In this case, the length Lₐ of the sheet P at the position in the width direction where the first start trigger sensor 3a and the first stop trigger sensor 4a are provided, can be obtained based on the following formula (3) by the length detecting unit 72.

Lₐ=(nₐ/N)×2πr+Lₛₐ (3)

Here, Lₛₐ is the distance between the first start trigger sensor 3a and the first stop trigger sensor 4a in in the conveying direction of the sheet P.

Furthermore, the length Lb of the sheet P at the position in the width direction where the second start trigger sensor 3b and the second stop trigger sensor 4b are provided, can be obtained based on the following formula (4) by the length detecting unit 72.

L_{b}=(n_{b}/N)×2πr+L_{sb} (4)

Here, L_{sb} is the distance between the second start trigger sensor 3b and the second stop trigger sensor 4b in the conveying direction of the sheet P.

Generally, the conveying speed of the sheet P varies according to the precision of the outer shape of the roller conveying the sheet P (particularly the driving roller 12), the core deflection precision, etc., the rotation precision of the motor, etc., and the precision in the power transmitting mechanism such as a gear and a belt. Furthermore, the conveying speed of the sheet P also varies due to a slip phenomenon between the driven roller 12 and the sheet P, and a loosening phenomenon in the sheet P caused by the difference in the sheet conveying speed between the conveying unit on upstream side and the downstream side. Therefore, the pulse period and the pulse width output from the encoder 18 constantly change; however, the number of pulses does not change.

Therefore, the length detecting unit 72 detects the length of the sheet P based on the number of pulses, and can thus obtain the length of the sheet P with high precision without being affected by variations in the conveying speed of the sheet P.

Furthermore, the length detecting unit 72 can also obtain the relative ratio, such as the ratio of the lengths of different sheets P, and the ratio of the lengths of the first side and the second side. For example, the length detecting unit 72 can obtain the difference ΔLₐ and the expansion and contraction ratio Rₐ of the length of the sheet P before and after an image is formed on the first side, at a position in the width direction where the first start trigger sensor 3a and the first stop trigger sensor 4a are provided, as follows.

For example, assuming that N=2800[/r], r=9 [mm], Lₛₐ=40 [mm], and the pulse count number nₐ₁ of the sheet P1 before an image is formed on the first side is 18816[/r], the length Lₐ₁ of the sheet P1 before an image is formed on the first side can be obtained as follows.

Lₐ₁=(18816/2800)×2π9+40=420.00 [mm]

Furthermore, when the pulse count number nₐ₂ of the sheet P2 before an image is formed on the first side is 18759[/r], the length Lₐ₂ of the sheet P2 before an image is formed on the first side can be obtained as follows.

Lₐ₂=(18759/2800)×2π×9+40=418.86 [mm]

Therefore, the difference ΔLₐ and the expansion and contraction ratio Rₐ of the length of the sheet P before and after an image is formed on the first side, is obtained as follows.

ΔLₐ=420.00−418.86=1.14 [mm]

Rₐ=418.86/420.00×100=99.73[%]

Note that a description is given of an example where the length detecting unit 72 obtains the expansion and contraction ratio Rₐ based on the lengths Lₐ₁, Lₐ₂ of the sheet P before and after an image is formed on the first side; however, the expansion and contraction ratio Rₐ may be obtained as follows, based on the pulse count numbers nₐ₁, nₐ₂ of the sheet P before and after an image is formed on the first side.

Rₐ=nₐ₂/nₐ₁=18759/18816=99.70[%]

Furthermore, the length detecting unit 72 may obtain the difference ΔL_{b} and the expansion and contraction ratio R_{b} of the length of the sheet P before and after an image is formed on the first side based on a similar calculation, at a position in the width direction where the second start trigger sensor 3b and the second stop trigger sensor 4b are provided.

(Sheet Shape Detection)

The shape detecting unit 74 obtains the shape of the sheet P before and after an image is formed on the first side, based on a width detection result of the sheet P obtained by the width detecting unit 73 and a length detection result of the sheet P obtained by the length detecting unit 72.

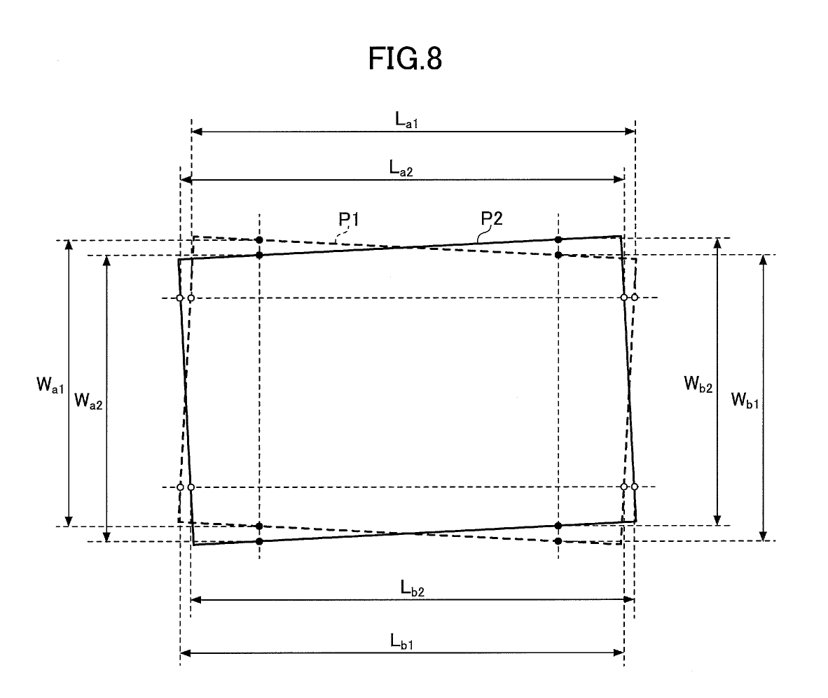

As illustrated in FIG. 8, the width detecting unit 73 obtains the widths Wₐ₁, W_{b1} of the sheet P1 before an image is formed on the first side and the widths Wₐ₂, W_{b2} of the sheet P2 after an image is formed on the first side. Furthermore, as indicated by black circles in FIG. 8, the width detecting unit 73 detects four edge positions of the sheet P in the width direction respectively before and after an image is formed on the first side.

The length detecting unit 72 obtains the lengths Lₐ₁, L_{b1} of the sheet P1 before an image is formed on the first side, and lengths Lₐ₂, L_{b2} of a sheet P2 after an image is formed on the first side. Furthermore, as indicated by white circles ◯ in FIG. 8, the length detecting unit 72 detects four edge positions of the sheet P in the conveying direction respectively before and after an image is formed on the first side.

The shape detecting unit 74 can obtain the shape of the sheet before and after an image is formed on the first side, based on the width and the edge position in the width direction of the sheet P detected by the width detecting unit 73, and the length and the edge position in the conveying direction of the sheet P detected by the length detecting unit 72.

As described above, the shape detecting unit 74 can detect the shape of the sheet P even when the shape of the sheet P is deformed into a shape other than a rectangle, by obtaining the shape based on edge positions detected at a plurality of positions in both the width direction and the conveying direction.

Note that the number of width detection positions of the sheet P detected by the width detecting unit 73 and the number of length detection positions of the sheet P detected by the length detecting unit 72, are preferably as many as possible, because the shape detection precision of the sheet P by the shape detecting unit 74 will increase. For example, by increasing the number of times of acquiring the output from the CIS 5 by the width detecting unit 73, it is possible to increase the width detection positions of the sheet P. Furthermore, for example, by increasing the number of start trigger sensors 3 and the number of stop trigger sensors 4 provided, it is possible to increase the length detection positions of the sheet P.

(Image Correction)

When the shape detecting unit 74 detects the shape of the sheet P, the image correcting unit 75 corrects the image to be formed on the sheet P by the image forming unit.

For example, the image correcting unit 75 corrects the size, the position, the shape, etc., of the image to be formed on the second side of the sheet P, based on the shape of the sheet P after an image is formed on the first side, detected by the shape detecting unit 74. Furthermore, the image correcting unit 75 may correct the size, the position, the shape, etc., of the image to be formed on at least one of the first side and the second side of a subsequent sheet that is conveyed next, based on the shape of the sheet P after an image is formed on the first side. As the image correcting unit 75 corrects the images to be formed on the first side and the second side according to the change in the shape of the sheet P, the accuracy of image positions on both sides of a sheet when performing double-sided printing is further improved.

As described above, in the first embodiment, even when the sheet P is deformed into a shape other than a rectangle, the shape detecting unit 74 can obtain the shape of the sheet P with high precision. Therefore, as the image correcting unit 75 corrects the image to be formed on the sheet P based on the detected shape, printing can be performed according to the change in shape of the sheet P, and the accuracy of image positions on both sides of a sheet is improved when performing double-sided printing.

### Second Embodiment

Next, a description is given of a second embodiment with reference to drawings. Note that descriptions of the same elements as those described in the above embodiment are omitted.

In the image forming apparatus 100 according to the second embodiment, a detection-use image is formed on the first side of the sheet P, and the shape detecting unit 74 detects the shape of the detection-use image together with the shape of the sheet P. As the image correcting unit 75 corrects the image to be formed on the sheet P based on the shapes of the sheet P and the detection-use image detected by the shape detecting unit 74, the accuracy of image positions on both sides of a sheet at the time of double-sided printing is further improved.

### <Detection of Sheet Shape and Detection-Use Image Shape>

(Detection of Sheet Width and Detection-Use Image Width)

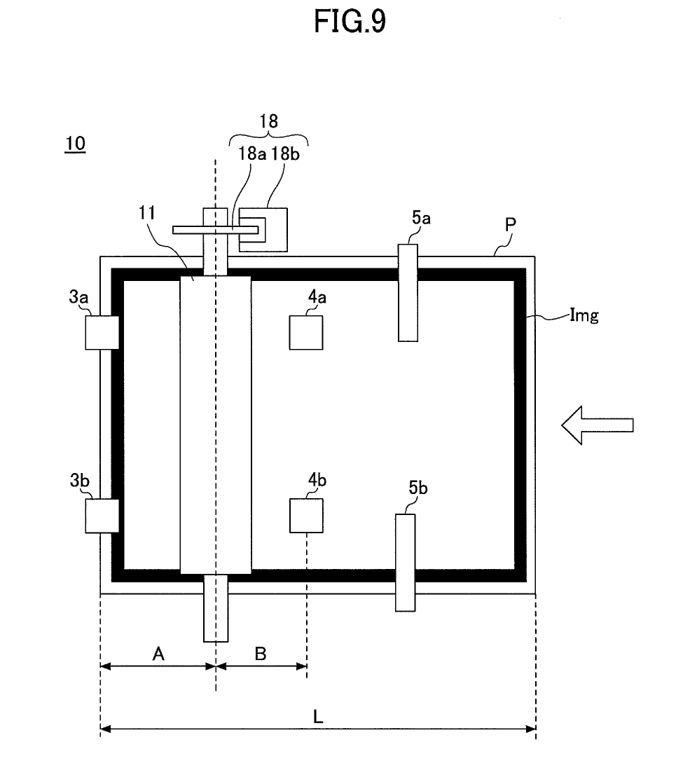

FIG. 9 is a plan view of an example of a schematic configuration of the shape measuring device 10 according to the second embodiment.

As illustrated in FIG. 9, after a detection-use image Img is formed on the first side of the sheet P, the sheet P is reversed and conveyed, and when the sheet P passes through the shape measuring device 10 again, the shape of the detection-use image Img is detected together with the shape of the sheet P.

In the shape measuring device 10 according to the second embodiment, the start trigger sensor 3, the stop trigger sensor 4, and the CIS 5 are provided on the side of the first side of the sheet P that is reversed and conveyed, and these elements detect the edges of the sheet P and the detection-use image Img.

The detection-use image Img formed on the first side of the sheet P is, for example, an image pattern shaped as a rectangular frame, having sides formed along the periphery of the sheet P. For example, the detection-use image Img is in one color among any one of YMCK, and is formed in a color that has a large contrast with respect to the color of the sheet P. In the present embodiment, the detection-use image Img is formed in black, which has a large contrast with respect to the white color of the sheet P. Note that the configuration of the detection-use image Img such as the shape, the color, etc., is not limited to the example of the present embodiment; the detection-use image Img may have other shapes, colors, etc.

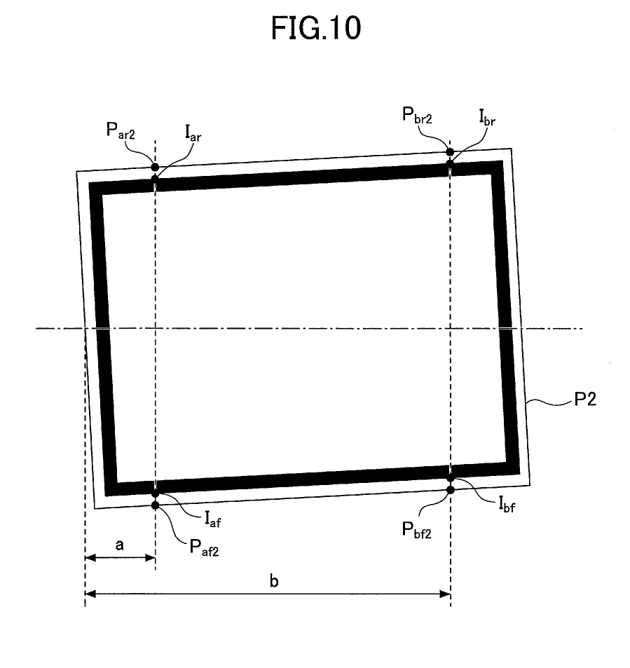

FIG. 10 illustrates an example of edge detection results of the sheet P and the detection-use image Img obtained by the CIS 5 according to the second embodiment.

In the CIS 5, a plurality of pixels are arranged in the width direction, which receive reflection light from the sheet P or the detection-use image Img, and output signals according to the amount of received light. The width detecting unit 73 acquires, as detection pixels corresponding to the width direction edge position of the sheet P or the detection-use image Img, the number of pixels of the CIS 5 from a pixel at one edge side to the pixel from which the output signal value of the pixel changes according to whether there is the sheet P or whether there is the detection-use image Img.

As illustrated in FIG. 10, the width detecting unit 73 acquires detection pixels P_{af2}, Pₐᵣ₂, corresponding to the width direction edge of the leading edge side, and detection pixels P_{bf2}, P_{br2}, corresponding to the width direction edge of the trailing edge side, in a sheet P2 after a detection-use image Img is formed on the first side. Furthermore, the width detecting unit 73 acquires detection pixels I_{af}, Iₐᵣ, corresponding to the width direction edge of the detection-use image Img on the leading edge side on the sheet P2, and detection pixels I_{bf}, I_{br}, corresponding to the width direction edge of the detection-use image Img on the trailing edge side on the sheet P2. The width detecting unit 73 can obtain the width of the sheet P2 on which the detection-use image Img is formed on the first side and the width of the detection-use image Img, based on the difference in the detection pixels at the same length from the leading edge of the sheet P as described above.

Note that the width detecting unit 73 may acquire the detection pixels P_{af1}, Pₐᵣ₁, P_{bf1}, P_{br1}, corresponding to the width direction edge of the sheet P1 as illustrated in FIG. 6, when the sheet P1 before an image is formed on the first side passes through the shape measuring device 10. It will become possible to obtain the expansion and contraction ratio and the width change amount of the sheet P before and after an image is formed on the first side.

(Detection of Sheet Length and Detection-Use Image Length)

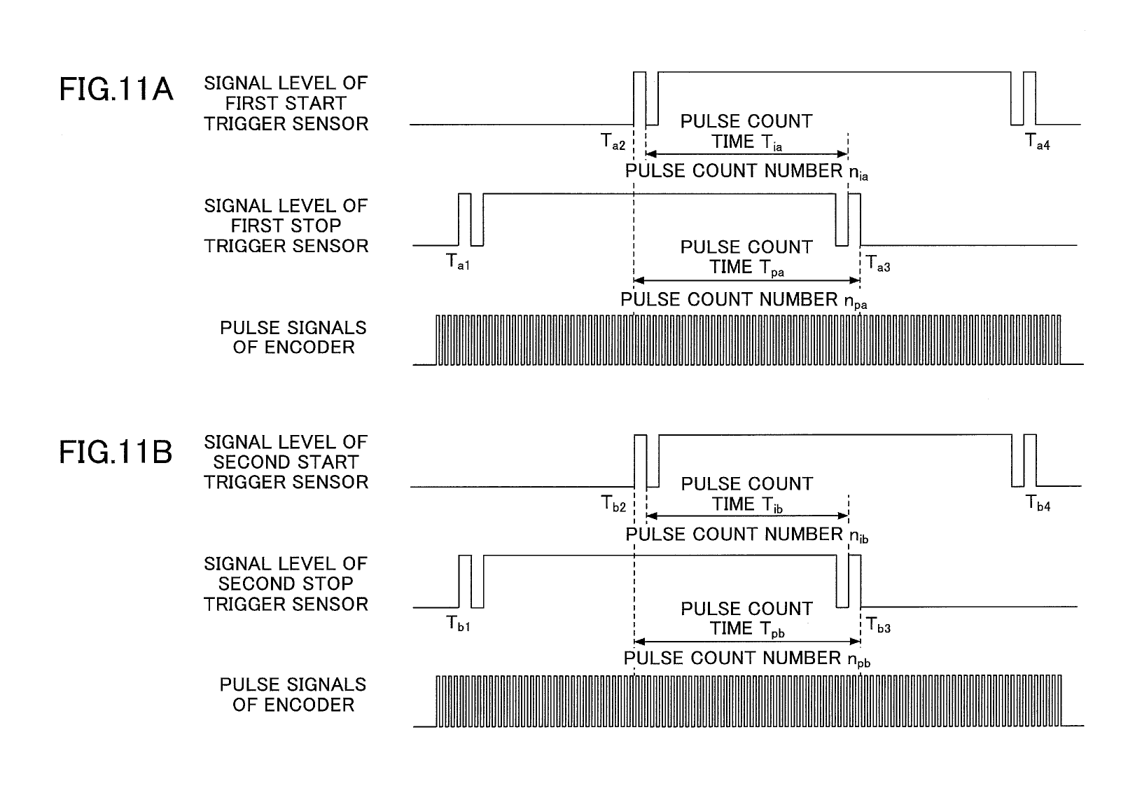

FIGS. 11A and 11B illustrate an output example of the start trigger sensor 3, the stop trigger sensor 4, and the encoder 18 when the sheet P on which the detection-use image Img is formed on the first side passes through the shape measuring device 10, according to the second embodiment. FIG. 11A illustrates an output example of the first start trigger sensor 3a, the first stop trigger sensor 4a, and the encoder 18. Furthermore, FIG. 11B illustrates an output example of the second start trigger sensor 3b, the second stop trigger sensor 4b, and the encoder 18.

As illustrated in FIGS. 11A and 11B, after the leading edge of the sheet P is detected by the start trigger sensor 3 and the stop trigger sensor 4 (times Tₐ₁, Tₐ₂, T_{b1}, T_{b2}), the signal levels of the respective sensors are temporarily decreased. This is because the detection-use image Img passing through the detection positions of the respective sensors has diffusely reflected the light, and the amount of received light at the respective sensors has decreased.

Furthermore, after the trailing edge of the sheet P is detected by the start trigger sensor 3 and the stop trigger sensor 4 (times Tₐ₃, Tₐ₄, T_{b3}, T_{b4}), the signal levels of the respective sensors are temporarily decreased. Similar to the case of the detecting the leading edge, this is because the detection-use image Img passing through the detection positions of the respective sensors has diffusely reflected the light, and the amount of received light at the respective sensors has decreased.

Similar to the first embodiment, the length detecting unit 72 can obtain the length of the sheet P2 by the above formulas (3), (4) by using the pulse count numbers nₚₐ, n_{pb} counted at the pulse count times Tₚₐ, T_{pb} by the pulse counting unit 71.

Furthermore, the pulse counting unit 71 counts the pulse signals of the encoder 18, from when the signal level of the start trigger sensor 3 has decreased after detecting the leading edge of the sheet P, to when the signal level of the stop trigger sensor 4 temporarily decreases before detecting the trailing edge of the sheet P and then increases again. As illustrated in FIGS. 11A and 11B, the length detecting unit 72 can obtain the length of the detection-use image Img by the above formulas (3), (4) by using the pulse count numbers nᵢₐ, n_{ib} counted at the pulse count times Tᵢₐ, T_{ib} by the pulse counting unit 71.

(Detection of Sheet Shape and Detection-Use Image Shape)

The shape detecting unit 74 obtains the shape of the sheet P based on the width detection result of the sheet P obtained by the width detecting unit 73 and the length detection result of the sheet P obtained by the length detecting unit 72. Furthermore, the shape detecting unit 74 obtains the shape of the detection-use image Img based on the width detection result of the detection-use image Img obtained by the width detecting unit 73 and the length detection result of the detection-use image Img obtained by the length detecting unit 72.

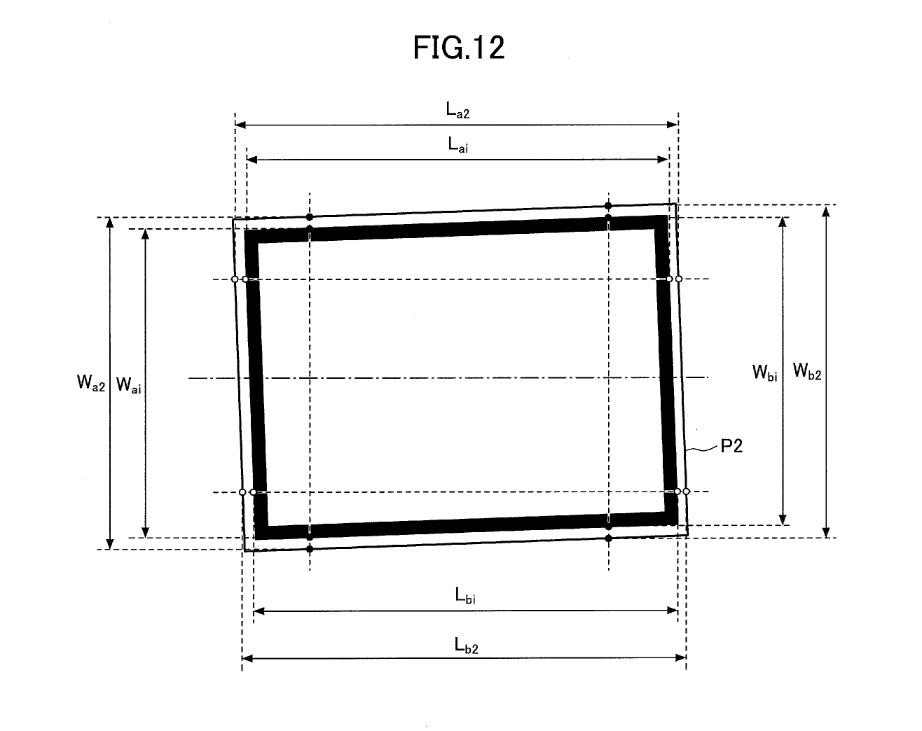

As illustrated in FIG. 12, the width detecting unit 73 obtains the widths Wₐ₂, W_{b2} of the sheet P2 after the detection-use image Img is formed on the first side and the widths Wₐᵢ, W_{bi} of the detection-use image Img. Furthermore, as indicated by black circles in FIG. 12, the width detecting unit 73 detects four edge positions of the sheet P2 in the width direction after the detection-use image Img is formed on the first side and four edge positions of the detection-use image Img in the width direction.

The length detecting unit 72 obtains the lengths Lₐ₂, L_{b2} of the sheet P2 after the detection-use image Img is formed on the first side, and lengths Lₐᵢ, L_{bi} of the detection-use image Img. Furthermore, as indicated by white circles ◯ in FIG. 12, the length detecting unit 72 detects four edge positions of the sheet P2 in the conveying direction after the detection-use image Img is formed on the first side and four edge positions of the detection-use image Img in the conveying direction.

The shape detecting unit 74 can obtain the shape of the sheet P2 on which the detection-use image Img is formed on the first side, based on the width and the edge position in the width direction of the sheet P2 detected by the width detecting unit 73, and the length and the edge position in the conveying direction of the sheet P2 detected by the length detecting unit 72. Furthermore, the shape detecting unit 74 can obtain the shape of the detection-use image Img, based on the width and the edge position in the width direction of the detection-use image Img detected by the width detecting unit 73, and the length and the edge position in the conveying direction of the detection-use image Img detected by the length detecting unit 72.

As described above, the shape detecting unit 74 can detect not only the shape of the sheet P, but also the shape of an image formed on the sheet P. Furthermore, the shape detecting unit 74 is able to detect the shape of the sheet P and the detection-use image Img even when the shape of the sheet P and the detection-use image Img is deformed into a shape other than a rectangle, by obtaining the shape based on edge positions detected at a plurality of positions in both the width direction and the conveying direction.

Note that the number of width detection positions of the sheet P and the detection-use image Img detected by the width detecting unit 73 and the number of length detection positions of the sheet P and the detection-use image Img detected by the length detecting unit 72, are preferably as many as possible, because the shape detection precision by the shape detecting unit 74 will increase.

(Image Correction)

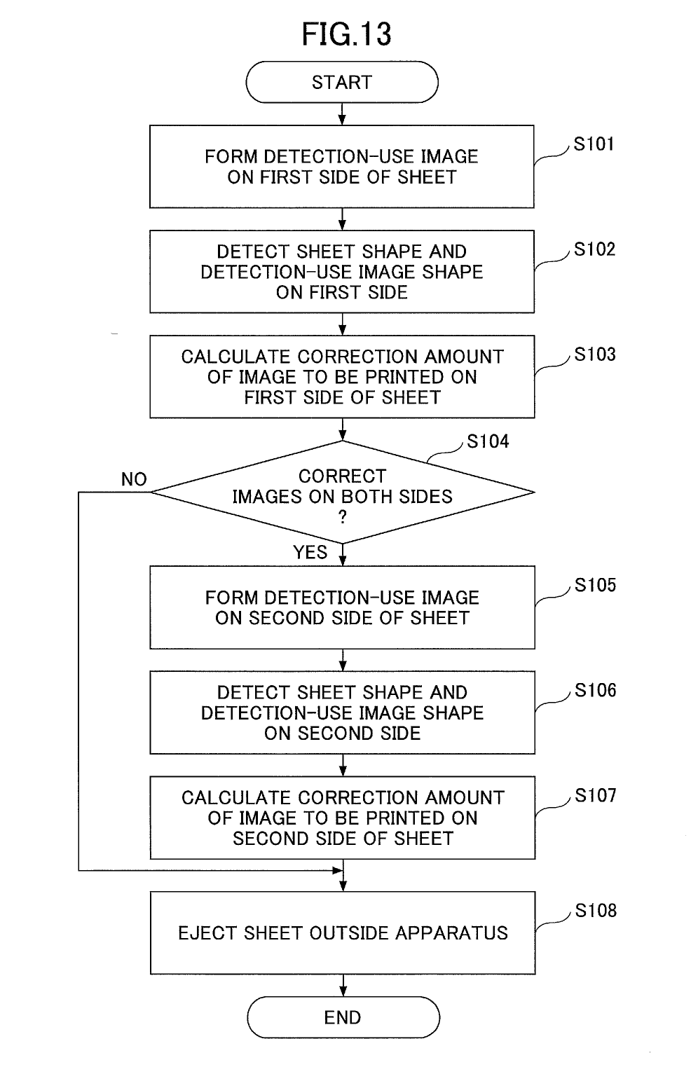

FIG. 13 is an example of a flowchart of an image correcting process according to the second embodiment. In the image forming apparatus 100, for example, before forming an image on the sheet P based on input image data, the image correcting process of FIG. 13 is executed to calculate the correction amount of the image data.

First, in step S101, the image forming apparatus 100 forms the detection-use image Img on the first side of the sheet P. Next, in step S102, the shape measuring device 10 detects the edge of the sheet P which has had the detection-use image Img formed on the first side and then reversed and conveyed and the edge of the detection-use image Img. Furthermore, the shape detecting unit 74 detects the shape of the sheet P and the shape of the detection-use image Img formed on the first side of the sheet P, based on the detection results obtained by the length detecting unit 72 and the width detecting unit 73.

Next, in step S103, the image correcting unit 75 calculates the image correction amount in a case where the image data input in the image forming apparatus 100 is to be printed on the first side of the sheet P, based on the detected shape of the sheet P and the shape of the detection-use image Img. The image correcting unit 75 stores, in a storage unit, the calculated image correction amount to be used when printing the image data on the first side.

In step S104, the image correcting unit 75 determines whether to execute double-sided image correction of obtaining the image correction amount in the case of printing on the second side of the sheet P for handling double-sided printing.

When double-sided image correction is to be executed (YES in step S104), in step S105, the image forming apparatus 100 forms the detection-use image Img on the second side of the sheet P. Next, in step S106, the shape measuring device 10 detects the edge of the sheet P which has had the detection-use image Img formed on the second side and then reversed and conveyed and the edge of the detection-use image Img. Furthermore, the shape detecting unit 74 detects the shape of the sheet P and the shape of the detection-use image Img formed on the second side of the sheet P, based on the detection results obtained by the length detecting unit 72 and the width detecting unit 73.

Next, in step S107, the image correcting unit 75 calculates the image correction amount in a case where the image data input in the image forming apparatus 100 is to be printed on the second side of the sheet P, based on the detected shape of the sheet P and the shape of the detection-use image Img. The image correcting unit 75 stores, in a storage unit, the calculated image correction amount to be used when printing the image data on the second side.

In step S108, the sheet P, on which the detection-use image Img is formed on at least one side, is ejected outside the image forming apparatus 100, and the process ends.

As the image correcting unit 75 corrects the position, the size, etc., of the image to printed on the sheet P based on the calculated image correction amount, it is possible to perform printing in accordance with the change in the shape of the sheet P, and the accuracy of image positions on both sides of a sheet when performing double-sided printing is further improved.

As described above, in the second embodiment, the shape detecting unit 74 detects the shape of the detection-use image Img formed on the sheet P, and the image correcting unit 75 corrects the image to be formed on the sheet P based on the shape detection result of the detection-use image Img. Therefore, in the image forming apparatus 100, printing can be performed according to the change in shape of the sheet P, and the accuracy of image positions on both sides of a sheet is improved when performing double-sided printing.

### Third Embodiment

Next, a description is given of a third embodiment with reference to drawings. Note that descriptions of the same elements as those described in the above embodiments are omitted.

In the image forming apparatus 100 according to the third embodiment, the detection-use image Img is formed on at least one side of the sheet P, and a margin detecting unit detects the size of the margin between the periphery of the sheet P and the detection-use image Img.

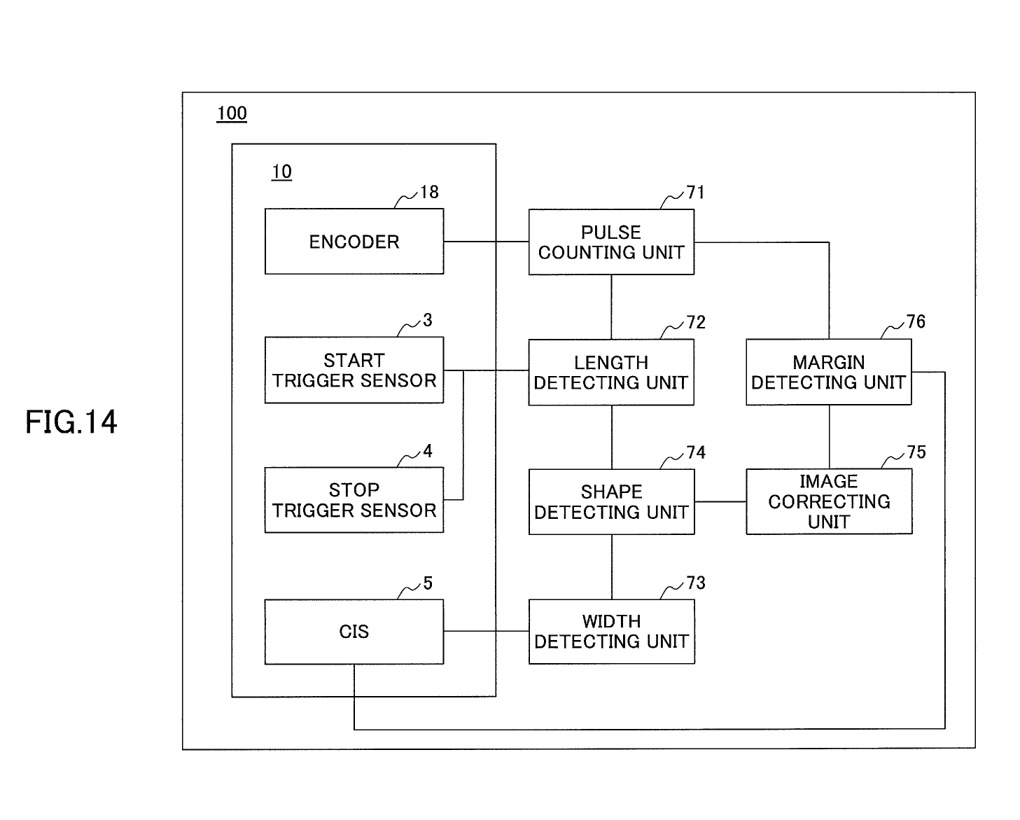

FIG. 14 is a functional block diagram of an example of the image forming apparatus 100 according to the third embodiment.

The image forming apparatus 100 according to the third embodiment includes a margin detecting unit 76, as illustrated in FIG. 14. The margin detecting unit 76 detects the margin between the periphery of the sheet P and the detection-use image Img formed on the sheet P.

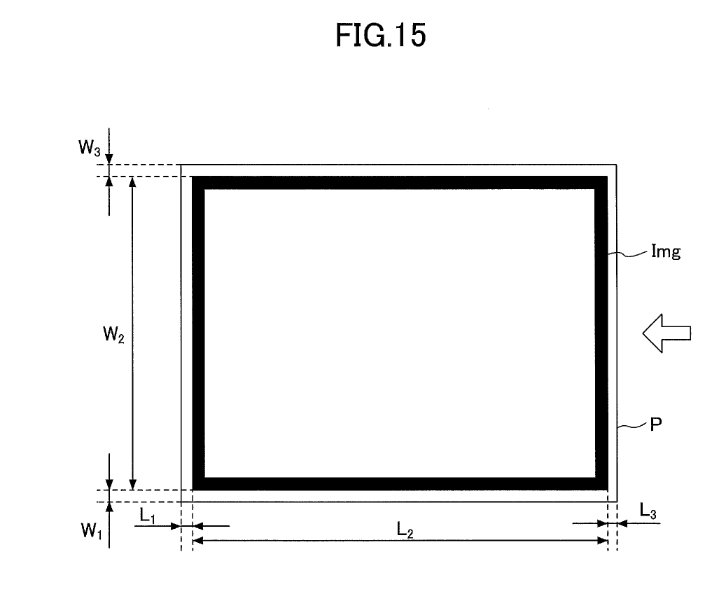

FIG. 15 illustrates an example of a margin of the sheet P detected by the margin detecting unit 76 in the third embodiment.

The margin detecting unit 76 detects, as margins, an interval L₁ between the leading edge of the sheet P and the leading edge of the detection-use image Img, and an interval L₃ between the trailing edge of the detection-use image Img and the trailing edge of the sheet P, in the conveying direction of the sheet P, as illustrated in FIG. 15. Furthermore, the margin detecting unit 76 detects, as margins, an interval W₁ between one edge side of the sheet P and one edge side of the detection-use image Img, and an interval W₃ between the other edge side of the sheet P and the other edge side of the detection-use image Img, in the width direction of the sheet P.

Furthermore, at the same time as the margin detecting unit 76 detects the margins, the length detecting unit 72 detects the length L₂ of the detection-use image Img, and the width detecting unit 73 detects the width W₂ of the detection-use image Img.

Note that the detection-use image Img is preferably formed on the sheet P to have the largest size that can be formed by the image forming apparatus 100.

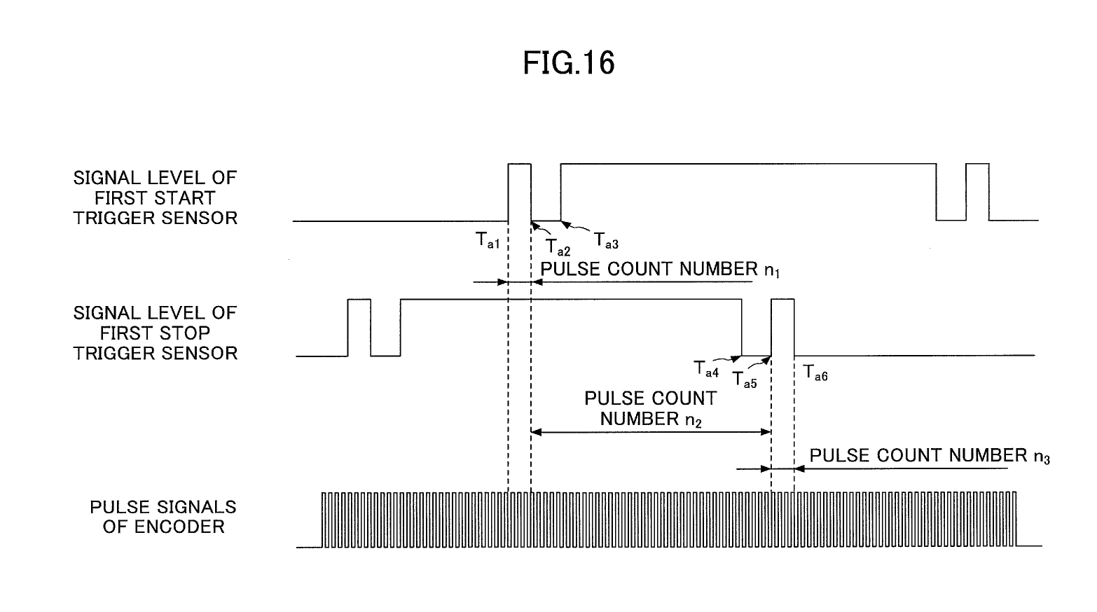

FIG. 16 illustrates an output example of the first start trigger sensor 3a, the first stop trigger sensor 4a, and the encoder 18 according to the third embodiment.

As illustrated in FIG. 16, when the sheet P on which the detection-use image Img is formed passes through the shape measuring device 10, the signal levels of the first start trigger sensor 3a and the first stop trigger sensor 4a change.

Here, the pulse counting unit 71 counts the pulses output from the encoder 18 as described below, and acquires pulse count numbers n₁, n₂, n₃.

The pulse count number n₁ is the pulse count result obtained between the time Tₐ₁ at which the leading edge of the sheet P has passed the detection position of the first start trigger sensor 3a, and the time Tₐ₂ at which the leading edge of the detection-use image Img has passed the detection position of the first start trigger sensor 3a.

The pulse count number n₂ is the pulse count result obtained between the time Tₐ₂ at which the leading edge of the detection-use image Img has passed the detection position of the first start trigger sensor 3a, and the time Tₐ₅ at which the trailing edge of the detection-use image Img has passed the detection position of the first stop trigger sensor 4a.

The pulse count number n₃ is the pulse count result obtained between the time Tₐ₅ at which the trailing edge of the detection-use image Img has passed the detection position of the first stop trigger sensor 4a, and the time Tₐ₆ at which the trailing edge of the sheet P has passed the detection position of the first stop trigger sensor 4a.

By using the pulse count numbers acquired by the pulse counting unit 71, it is possible to obtain the margins L₁, L₃, and the length L₂ of the detection-use image Img, from the following formula (5).

L=(n/N)×2πr (5)

Note that n is the pulse count number, r is the radius of the driven roller 11, and N is the encoder pulse number of one rotation of the driven roller 11.

The margin detecting unit 76 uses the pulse count numbers n₁, n₃ to obtain the intervals L₁, L₃ between the sheet P and the detection-use image Img from the above formula (5). Furthermore, the length detecting unit 72 uses the pulse count number n₂ to obtain the length L₂ of the detection-use image Img from the above formula (5).

By forming the detection-use image Img on both sides of the sheet P and obtaining the intervals L₁, L₃ of the margins and the length L₂ of the detection-use image Img on both sides of the sheet P, it is possible to obtain the deviations of image positions on both sides of a sheet P and the front and back image magnification ratio.

For example, when N=2800 [/r], r=9 [mm], and the pulse count number n₁ on the first side of the sheet P is 1016, the interval of the margin L₁ is obtained as follows.

L₁=(1016/2800)×2π×9=20.52 [mm]

Furthermore, when the pulse count number n₃ on the second side of the sheet P is 1059, the interval of the margin L₃ is obtained as follows.

L₃=(1059/2800)×2π×9=21.39 [mm]

In the image forming apparatus 100, when the sheet P is reversed and conveyed, the leading edge and the trailing edge are switched, and therefore by obtaining the difference between the interval L₁ of the margin on the first side of the sheet P and the interval L₂ of the margin on the second side of the sheet P, it is possible to obtain the image position deviation E₁ between the front and back sides of the sheet P in the conveying direction.

E₁=|L₁−L₃|=|120.52−21.391=0.87 [mm]

Furthermore, the length detecting unit 72 obtains the length L₂ of the detection-use image Img on both the first side and the second side of the sheet P, from the pulse count number n₂ on the first side and the second side of the sheet P. For example, in a case where the pulse count number is n₂=17503 on the first side of the sheet P, and the pulse count number is n₂=17555 on the second side of the sheet P, the length L₂₁ of the detection-use image Img on the first side of the sheet P and the length L₂₂ of the detection-use image Img on the second side of the sheet P are obtained as follows.

L₂₁=(17503/2800)×2π×9=353.49 [mm]

L₂₂=(17555/2800)×2π×9=354.54 [mm]

Therefore, in this case, the front and back image size difference ΔL₂ of the sheet P in the conveying direction of the sheet P and the front and back image magnification ratio Lᵣ are obtained as follows.

ΔL₂=|L₂₁−L₂₂|=|1353.49−354.54=1.05 [mm]

Lᵣ=L₂₂/L₂₁×100==354.54/353.49×100=100.3 [%]

Note that the margin detecting unit 76 and the length detecting unit 72 are similarly able to obtain the margins L₁, L₂ of the sheet P and the length L₂ of the detection-use image Img based on output from the second start trigger sensor 3b and the second stop trigger sensor 4b.

Furthermore, the margin detecting unit 76 can obtain the intervals W₁, W₃ of margins on the front and back sides of the sheet P, from the edge positions in the width direction of the sheet P and the detection-use image Img detected by the CIS 5. Furthermore, the width detecting unit 73 can obtain the width W₃ of the detection-use image Img on the front and back sides of the sheet P, from the edge positions of the detection-use image Img in the width direction detected by the CIS 5.

Therefore, it is possible to obtain the front back image size difference ΔW₂ of the sheet P in the width direction of the sheet P, from the intervals W₁, W₃ of margins on the front and back sides of the sheet P. Furthermore, the front back magnification ratio Wᵣ can be obtained from the width W₃ of the detection-use image Img on the front and back sides of the sheet P.

The image correcting unit 75 acquires, as the correction amounts of the image, the front back image size difference ΔL₂, ΔW₂, and the front back image magnification ratio Lᵣ, Wᵣ obtained as described above, and corrects the position and the size of the image to be printed on the sheet P.

As described above, the image forming apparatus 100 according to the third embodiment forms a detection-use image Img on the front and back sides of the sheet P, and detects the margin between the sheet P and the detection-use image Img and the size of the detection-use image Img. Therefore, it is possible to perform printing according to the changes in the shape of the sheet P in the image forming apparatus 100, and the accuracy of image positions on both sides of a sheet when performing double-sided printing is further improved.

Note that, as illustrated in FIG. 16, the output of the start trigger sensor 3 changes significantly at the time when the leading edge of the sheet P passes (time Tₐ₁), the at time when the outer periphery of the detection-use image Img passes (time Tₐ₂), and at the time when the inner periphery of the detection-use image Img passes (time Tₐ₃). Furthermore, the output of the stop trigger sensor 4 changes significantly at the time when the inner periphery of the detection-use image Img passes (time Tₐ₄), at the time when the outer periphery of the detection-use image Img passes (time Tₐ₅), and at the time when the trailing edge of the sheet P passes (time Tₐ₆).

Here, the pulse counting unit 71 may count the pulses, by setting the time Tₐ₂₃, which is the middle time between the time Tₐ₂ and the time Tₐ₃, as the time of detecting the leading edge of the detection-use image Img, and by setting the time Tₐ₄, which is the middle time between the time Tₐ₄ and the time Tₐ₅, as the time of detecting the trailing edge of the detection-use image Img.

There may be cases where the output of the start trigger sensor 3 and the stop trigger sensor 4 varies or includes noise according to the environment. Therefore, for example, by setting the time Tₐ₂, Tₐ₃, at which the output of the start trigger sensor 3 exceeds a predetermined threshold, as the time of detecting the leading edge or the trailing edge of the detection-use image Img, there may be a possibility that errors and variations occur in the detection result of the margin. Thus, as described above, when the pulse counting unit 71 counts the pulses by using the time Tₐ₂₃, Tₐ₄₅, which is the middle time between the time when the outer periphery of the detection-use image Img passes and the time when the inner periphery of the detection-use image Img passes, it is possible to reduce errors and variations, and detect the margin, etc., with high precision.

### Fourth Embodiment

Next, a description is given of a fourth embodiment with reference to drawings. Note that descriptions of the same elements as those described in the above embodiments are omitted.

In the image forming apparatus 100 according to the fourth embodiment, the detection-use image Img is formed on at least one side of the sheet P, and a skew detecting unit detects the tilt of the sheet P and the detection-use image Img. Based on the tilt detected by the skew detecting unit, the image correcting unit 75 corrects the image to be printed on the sheet P.

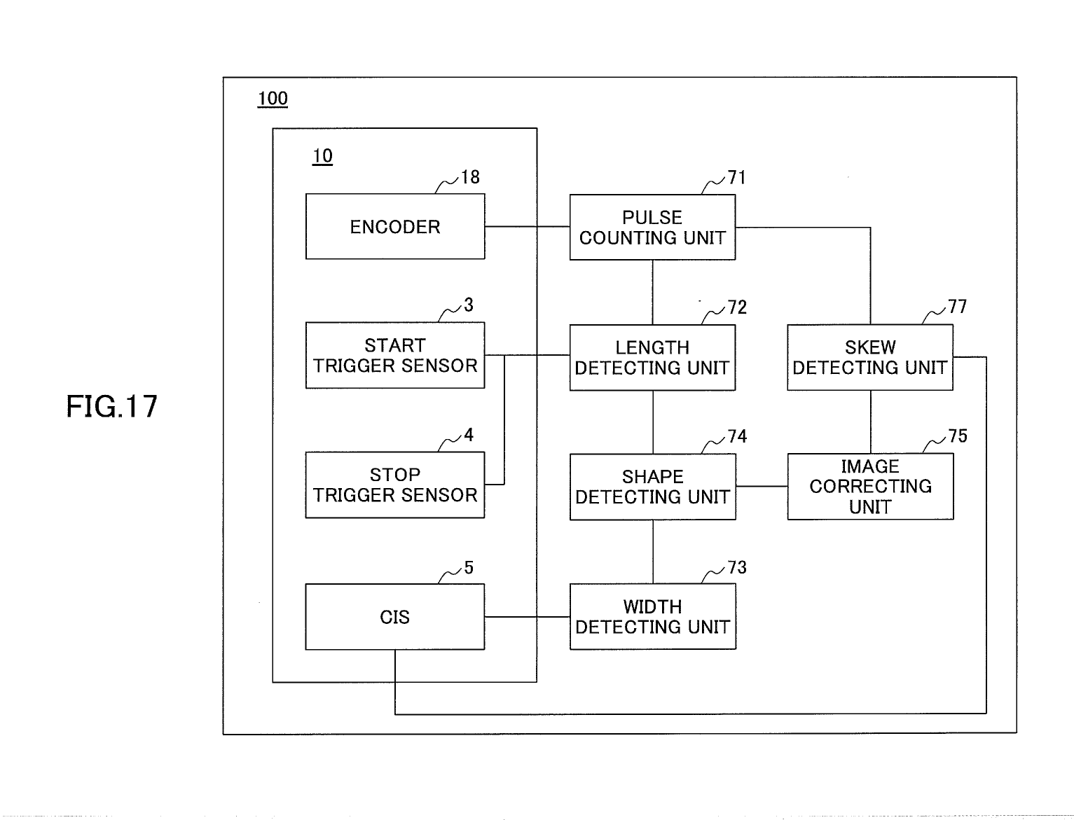

FIG. 17 is a functional block diagram of an example of the image forming apparatus 100 according to the fourth embodiment.

The image forming apparatus 100 according to the fourth embodiment includes a skew detecting unit 77, as illustrated in FIG. 17. The skew detecting unit 77 detects the tilt of the sheet P and the detection-use image Img formed on the sheet P.

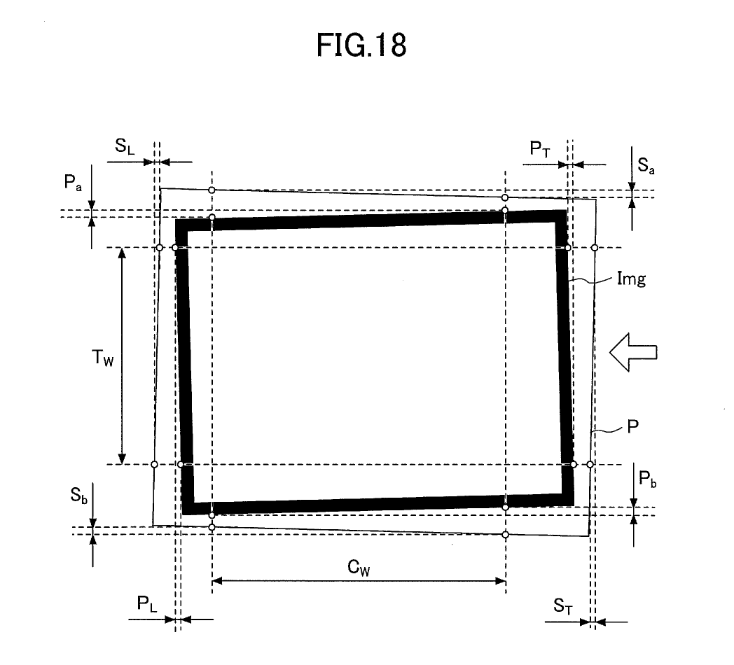

FIG. 18 illustrates an example where the sheet P on which a detection-use image Img is formed is conveyed in a direction indicated by the white arrow. Furthermore, in FIG. 18, the detection positions of the sheet P and the detection-use image Img by the start trigger sensor 3, the stop trigger sensor 4, and the CIS 5, are indicated by white circles ◯.

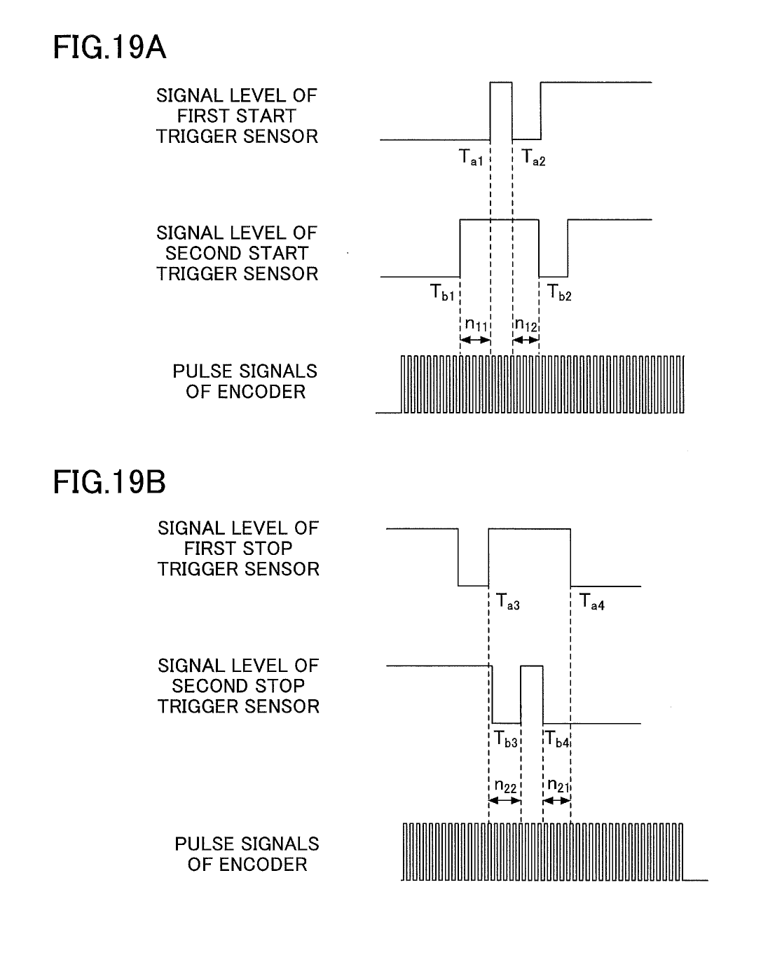

FIGS. 19A and 19B illustrate an output example of the start trigger sensor 3, the stop trigger sensor 4, and the encoder 18, in a case where the sheet P on which the detection-use image Img is formed is conveyed in the direction indicated by the arrow in FIG. 18.

FIG. 19A illustrates an output example when the leading edge of the sheet P and the detection-use image Img passes the detection position of the start trigger sensor 3. FIG. 19B illustrates an output example when the trailing edge of the sheet P and the detection-use image Img passes the detection position of the stop trigger sensor 4.

Here, the pulse counting unit 71 counts the pulses output from the encoder 18 as described below, and acquires pulse count numbers n₁₁, n₁₂, n₂₁, n₂₂.

The pulse count number n₁₁ is the pulse count result obtained between the time T_{b1} at which the leading edge of the sheet P has passed the detection position of the second start trigger sensor 3b, and the time Tₐ₁ at which the leading edge of the sheet P has passed the detection position of the first start trigger sensor 3a.

The pulse count number n₁₂ is the pulse count result obtained between the time Tₐ₂ at which the leading edge of the detection-use image Img has passed the detection position of the first start trigger sensor 3a, and the time T_{b2} at which the leading edge of the detection-use image Img has passed the detection position of the second start trigger sensor 3b.

The pulse count number n₂₁ is the pulse count result obtained between the time T_{b4} at which the trailing edge of the sheet P has passed the detection position of the second stop trigger sensor 4b, and the time Tₐ₄ at which the trailing edge of the sheet P has passed the detection position of the first stop trigger sensor 4a.

The pulse count number n₂₂ is the pulse count result obtained between the time Tₐ₃ at which the trailing edge of the detection-use image Img has passed the detection position of the first stop trigger sensor 4a, and the time T_{b3} at which the trailing edge of the detection-use image Img has passed the detection position of the second stop trigger sensor 4b.

The skew detecting unit 77 uses the pulse count numbers acquired by the pulse counting unit 71 to obtain the leading edge detection interval S_{L} and the trailing edge detection interval S_{T} of the sheet P, and the leading edge detection interval P_{L} and the trailing edge detection interval P_{T} of the detection-use image Img, illustrated in FIG. 18, by the following formulas.

S_{L}=(n₁₁/N)×2πr

S_{T}=(n₂₁/N)×2πr

P_{L}=(n₁₂/N)×2πr

P_{T}=(n₂₂/N)×2πr

Note that r is the radius of the driven roller 11, and N is encoder pulse number of one rotation of the driven roller 11.

Furthermore, the skew detecting unit 77 obtains the side edge detection intervals Sₐ, S_{b} of the sheet P and the side edge detection intervals Pₐ, P_{b} of the detection-use image Img, illustrated in FIG. 18, based on detection results obtained by the CIS 5.

Next, the skew detecting unit 77 obtains the tilt T_{SL} of the leading edge of the sheet P, the tilt T_{ST} of the trailing edge of the sheet P, the tilts T_{Sa} and T_{sb} of the side edges of the sheet P, the tilt T_{PL} of the leading edge of the detection-use image Img, the tilt T_{PT} of the trailing edge of the detection-use image Img, and the tilts T_{Pa} and T_{Pb} of the side edges of the detection-use image Img, by the following formulas.

T_{SL}=S_{L}/T_{W}

T_{ST}=S_{T}/T_{W}

T_{Sa}32 Sₐ/C_{W}

T_{Sb}=S_{b}/C_{S}

T_{PL}=P_{L}/T_{W}

T_{PT}=P_{T}/T_{W}

T_{Pa}=Pₐ/C_{W}

T_{Pb}=P_{b}/C_{W}

Note that the tilts T_{SL}, T_{ST}, T_{PL}, T_{PT} are the tilts with respect to the width direction orthogonal to the conveying direction of the sheet P. Furthermore, the tilts T_{Sa}, T_{Sb}, T_{Pa}, T_{Pb} are tilts with respect to the conveying direction of the sheet P.

As described above, the image correcting unit 75 acquires the tilts obtained as described above as correction amounts of the image, and corrects the tilt of the image to be printed on the sheet P.

Here, the image correcting unit 75 corrects the tilt of the image by setting the tilts according to the following conditions (1) through (4) set by the user.

(1) Match Shape of Image Printed on First Side with Shape of Sheet P

In this case, the image correcting unit 75 sets the leading edge tilt P_{PL}, the trailing edge tilt P_{PT}, and the side edge tilts P_{Pa} and P_{Pb} of the image to be printed on the first side of the sheet P, to be the same as the tilts of the sheet P after printing on one side obtained by the skew detecting unit 77 as follows.

P_{PL}=T_{SL}

P_{PT}=T_{ST}

P_{Pa}=T_{Sa}

P_{Pb}=T_{Sb}

(2) Match Shape of Image Printed on Second Side with Shape of Sheet P

In this case, the image correcting unit 75 sets the leading edge tilt P_{PL}′, the trailing edge tilt P_{PT}′, and the side edge tilts P_{Pa}′ and P_{Pb}′ of the image to be printed on the second side of the sheet P, to be the same as the tilts of the sheet P after printing on both sides obtained by the skew detecting unit 77 as follows.

P_{PL}′=T_{SL}′

P_{PT}′=T_{ST}′

P_{Pa}′=T_{Sa}+

P_{Pb}′=T_{Sb}′

Note that the tilts T_{SL}′, T_{ST}′, T_{Sa}′, T_{Sb}′ of the sheet P are tilts of the sheet P on which the detection-use image Img is formed on both sides, obtained by the skew detecting unit 77.

(3) Match Shape of Image Printed on Second Side with Shape of Image Printed on First Side of Sheet P

In this case, the image correcting unit 75 sets the leading edge tilt P_{PL}′, the trailing edge tilt P_{PT}′, and the side edge tilts P_{Pa}′ and P_{Pb}′ of the image to be printed on the second side of the sheet P, to be the same as the tilts of the detection-use image Img printed on the first side of the sheet P obtained by the skew detecting unit 77 as follows.

However, in order to match the tilts on the front and back sides of the sheet P, the symbols are inverted. Furthermore, in the image forming apparatus 100 according to the present embodiment, because the sheet P is reversed and conveyed after an image is printed on the first side, the tilts of the leading edge and the trailing edge are set by being switched between the first side and the second side.

P_{PL}′=−T_{PT}

P_{PT}′=−T_{PL}

P_{Pa}′=−T_{Pa}

P_{Pb}′=−T_{Pb}

### (4) Print Images on First Side and Second Side Regardless of Shape of Sheet P

In this case, the image correcting unit 75 sets the leading edge tilt P_{PL}, the trailing edge tilt P_{PT}, and the side edge tilts P_{Pa} and P_{Pb} of the image to be printed on the sheet P, to be zero as follows.

P_{PL}=0

P_{PT}=0

P_{Pa}=0

P_{Pb}=0

As described above, in the image forming apparatus 100 according to the fourth embodiment, the detection-use image Img is formed on the front and back sides of the sheet P, and the tilts of the sheet P and the detection-use image Img are detected. Therefore, in the image forming apparatus 100, it is possible to perform printing in accordance with the change in the shape of the sheet P, and the accuracy of image positions on both sides of a sheet when performing double-sided printing is further improved.

Furthermore, in the image forming apparatus 100 according to the fourth embodiment, similar to the third embodiment, the margin between the sheet P and the detection-use image Img, and the size of the detection-use image Img may be detected, and the position and the size may be corrected at the same time in addition to correcting the tilt of the image to be printed on the sheet P.

According to one embodiment of the present invention, an image forming apparatus is provided, which is capable of forming an image in accordance with a change in the shape of a recording medium.

The image forming apparatus is not limited to the specific embodiments described herein, and variations and modifications may be made without departing from the spirit and scope of the present invention.

1. An image forming apparatus comprising:
an image forming unit configured to form an image on a recording medium; the recording medium having a front edge, a back edge, a first side edge between the front edge and the back edge, and a second side edge between the front edge and the back edge;
an edge detecting unit configured to detect edge positions at a plurality of portions along each side of the recording medium being conveyed;
a shape detecting unit configured to detect a shape of the recording medium, based on an edge detection result obtained by the edge detecting unit;
an image correcting unit configured to correct the image to be formed on the recording medium, based on a change in the shape of the recording medium before and after image forming, the change being detected by the shape detecting unit; and
a conveying unit configured to convey the recording medium in a conveying direction;
wherein the edge detecting unit includes:
a front edge detecting unit configured to detect the front edge of the recording medium conveyed by the conveying unit, the front edge detecting unit being provided on a downstream side of the conveying unit;
a back edge detecting unit configured to detect the back edge of the recording medium conveyed by the conveying unit, the back edge detecting unit being provided on an upstream side of the conveying unit;
a first side edge detecting unit configured to detect the first side edge of the recording medium conveyed by the conveying unit, and
a second side edge detecting unit configured to detect the second side edge of the recording medium conveyed by the conveying unit;
wherein the shape detecting unit is configured to detect a shape of an image on the recording medium conveyed by the conveying unit.

2. (canceled)

3. The image forming apparatus according to claim 1, further comprising:
a conveying amount detecting unit configured to detect a conveying amount of the recording medium conveyed by the conveying unit;
a length detecting unit configured to detect a length of the recording medium in the conveying direction, based on a detection result obtained by the conveying amount detecting unit obtained from when the front edge detecting unit detects the front edge of recording medium to when the back edge detecting unit detects the back edge of the recording medium; and
a width detecting unit configured to detect a width of the recording medium, based on a detection result obtained by the first side edge detecting unit and the second side edge detecting unit, wherein
the shape detecting unit detects the shape of the recording medium based on a detection result obtained by the length detecting unit and a detection result obtained by the width detecting unit.

4. The image forming apparatus according to claim 3, wherein
the conveying unit is a pair of rollers including at least one roller that drivingly rotates, and
the conveying amount detecting unit measures a rotational frequency of the at least one roller of the pair of rollers.

5. An image forming apparatus comprising:
an image forming unit configured to form an image on a recording medium;
an edge detecting unit configured to detect edge positions at a plurality of portions along each side of the recording medium being conveyed;
a shape detecting unit configured to detect a shape of the recording medium., based on an edge detection result obtained by the edge detecting unit and
an image correcting unit configured to correct the image to be formed on the recording medium, based on a change in the shape of the recording medium before and after image forming, the change being detected by the shape detecting unit
wherein the image forming unit forms, on the recording medium, a detection-use image shaped as a rectangular frame having sides formed along a periphery of the recording medium,
wherein the edge detecting unit detects edge positions at a plurality of portions along each side of the detection-use image formed on the recording medium being conveyed,
wherein the shape detecting unit detects a shape of the detection-use image based on an edge detection result obtained by the edge detecting unit by detecting the detection-use image, and
wherein the image correcting unit corrects the image to be formed on the recording medium, based on the shape of the recording medium and the shape of the detection-use image.

6. The image forming apparatus according to claim 5, further comprising:
a margin detecting unit configured to detect a size of a margin between the periphery of the recording medium and a periphery of the detection-use image, based on the edge detection result of the recording medium and the edge detection result of the detection-use image obtained by the edge detecting unit, wherein
the image correcting unit corrects the image to be formed on the recording medium, based on a detection result obtained by the margin detecting unit.

7. The image forming apparatus according to claim 5, further comprising:
a skew detecting unit configured to detect a tilt of each side of the recording medium and each side of the detection-use image, based on the edge detection result of the recording medium and the edge detection result of the detection-use image obtained by the edge detecting unit, wherein
the image correcting unit corrects the image to be formed on the recording medium, based on a detection result obtained by the skew detecting unit.

8. The image forming apparatus according to claim 1, wherein the first side edge detection unit and the second side edge detection unit are provided directly opposite each other in the conveying direction.

9. The image forming apparatus according to claim 1, wherein the front edge detecting unit includes a first sensor and a second sensor, and the back edge detecting unit includes a third sensor and a fourth sensor.
